(19) United States
(12) Patent Application Publication
(10) Pub. No.: US 2014/0309005 A1
(43) Pub. Date: Oct. 16, 2014

(54) Card Game

(71) Applicant: John Hanlon, Concordville, PA (US)

(72) Inventor: John Hanlon, Concordville, PA (US)

(21) Appl. No.: 13/862,304

(22) Filed: Apr. 12, 2013

(51) Int. Cl. G07F 17/32

(52) U.S. Cl. CPC G07F 17/3293
USPC 463/11

(57) ABSTRACT

The method for playing cards provides a high scoring option and a low scoring option during each hand, including computer-implemented card games and game systems, such as card games distributed across a plurality of computing devices. Players take turns drawing a card from a master stack or a discard stack, and discarding a card in return. The cards have point designations. A High Game tally adds points to the winner's tally and a Low Game tally subtracts points from the winner's initial pool of points. The deck of card embodiments for use with the card game method can include indicia that can indicate point values for the card. A score card for use with the card game method includes a High Game tally column and a Low Game tally column. The deck of cards includes new designs.

### PRIORITY CLAIM, CROSS REFERENCE TO RELATED APPLICATIONS AND INCORPORATION BY REFERENCE

This application is a continuation-in-part of nonprovisional application of John Hanlon, Ser. No. 13,237,891, filed on Sep. 20, 2011, entitled: Card Game. This application is related to, claims priority under and claims the benefit of the earliest available effective filing dates from the following listed applications: nonprovisional application of John Hanlon, Ser. No. 13,237,891, filed on Sep. 20, 2011, entitled: Card Game; and, provisional application of John Hanlon, Ser. No. 61/384,708, filed on Sep. 20, 2010, entitled: Card Game. The entire disclosures of nonprovisional application of John Hanlon, Ser. No. 13,237,891, filed on Sep. 20, 2011, entitled: Card Game and provisional application of John Hanlon, Ser. No. 61/384,708, filed on Sep. 20, 2010, entitled: Card Game, are incorporated herein by reference.

### FIELD OF THE INVENTION

The invention includes but is not limited to card games, playing cards, score sheets and playing card designs, including computer-implemented card games and game systems, such as card games distributed across a plurality of computing devices.

### SUMMARY OF THE INVENTION

Embodiments of methods of the card game of the current invention provide a high scoring option and a low scoring option during each hand. In a Beginning Declaration Game, all of the players indicate whether they will be playing a High Game or a Low Game before viewing their cards. In an Ending Declaration Game the player who calls the end of a game, the “caller”, indicates whether that player is playing a High Game or a Low Game before the caller can know the contents of the hands of any of the other players.

Players take turns drawing a card from a master stack or a discard stack, and discarding a card in return. The cards have point designations.

The score for each player is tallied for a High Game or a Low Game, and if a game is for more than one hand, each player can have separate high game and low game scores. The High Game tally adds points to the winner's tally. The Low Game tally subtracts points from the winner's initial pool of points.

Players can decide to play as partners.

The invention includes embodiments of a deck of cards for use with the card game method of the invention. The embodiments of a deck of cards can include indicia that can indicate point values for the card.

The invention includes embodiments of a score card for use with the card game method of the invention. The score card includes a High Game tally column and a Low Game tally column.

The invention includes designs for embodiments of decks of cards for use with the card game method of the invention.

Some embodiments of the invention are implemented as an electronic or virtual game using one or more processor-based computing devices.

The card game may be played on one or more electronic devices, such as for example but not limited to, desktop computers, lap top computers, tablets, smart phones, and/or kiosks alone or in communication with other electronic devices. If more than one electronic device is utilized the devices may communicate with one another via wired or wireless interfaces. The electronic devices and the individuals utilizing the electronic devices may be located in close proximity to one another or may be located remote from one another. According to some embodiments, one or more players may be simulated by an electronic device.

### BRIEF DESCRIPTION OF THE DRAWINGS

The accompanying drawings, which are incorporated in and form a part of the specification, illustrate the embodiments of the present invention and, together with the description, serve to explain the principles of the invention.

FIGS. 1 and 1A are illustrations are score sheet embodiments of the invention.

FIGS. 2A-4 are flow chart of embodiments of the invention.

FIGS. 5-9 are embodiments of the face indicia of playing cards of the invention.

FIG. 10 is a pagination outline of the drawing sheets 10-1-10-8 that together make up drawing 10.

FIG. 12 is a rear elevational view of a playing card showing a new design;

FIG. 11 is a front elevational view thereof;

FIG. 13 is a side view thereof;

FIG. 14 is a top view thereof.

FIG. 16 is a rear elevational view of a playing card showing a new design;

FIG. 15 is a front elevational view thereof;

FIG. 17 is a side view thereof;

FIG. 18 is a top view thereof;

FIG. 19 is another front elevational view thereof;

FIG. 20 is another front elevational view thereof;

FIG. 21 is another front elevational view thereof; and

FIG. 22 is another front elevational view thereof.

FIG. 23 is a system diagram of an exemplary computer-implemented game system, in one embodiment of the invention; and

FIG. 24 is a flow chart showing an exemplary process for game play in the computer-implemented embodiment of FIG. 23.

### DETAILED DESCRIPTION OF EMBODIMENTS OF THE INVENTION

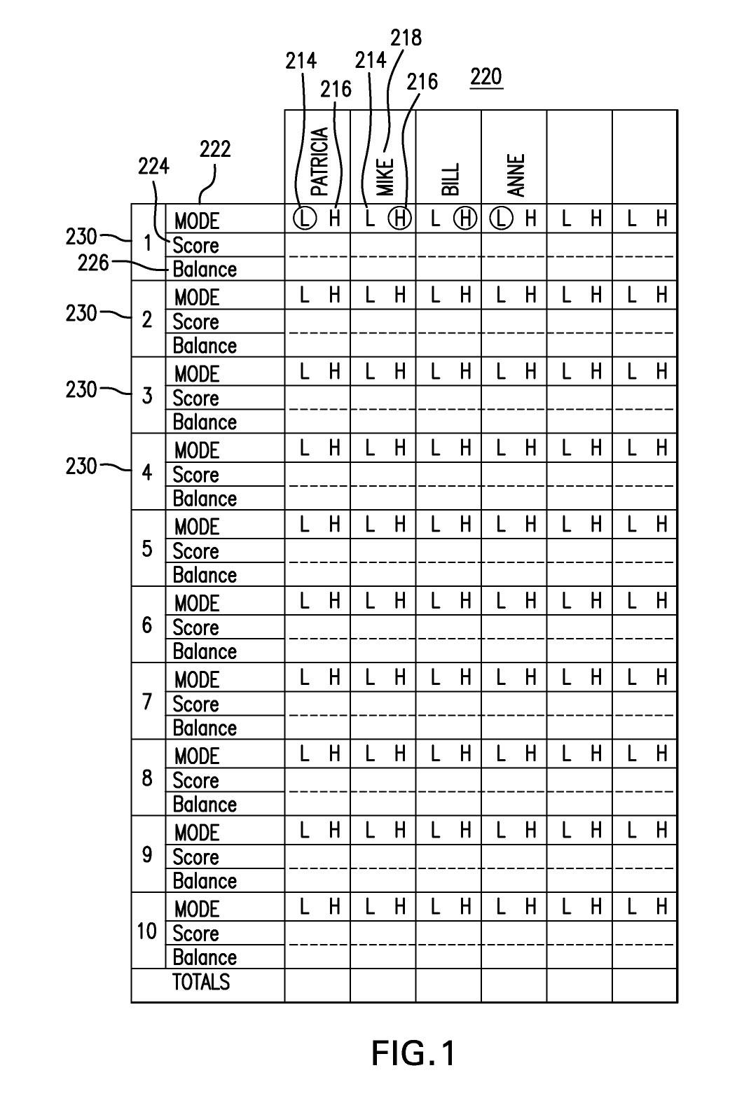

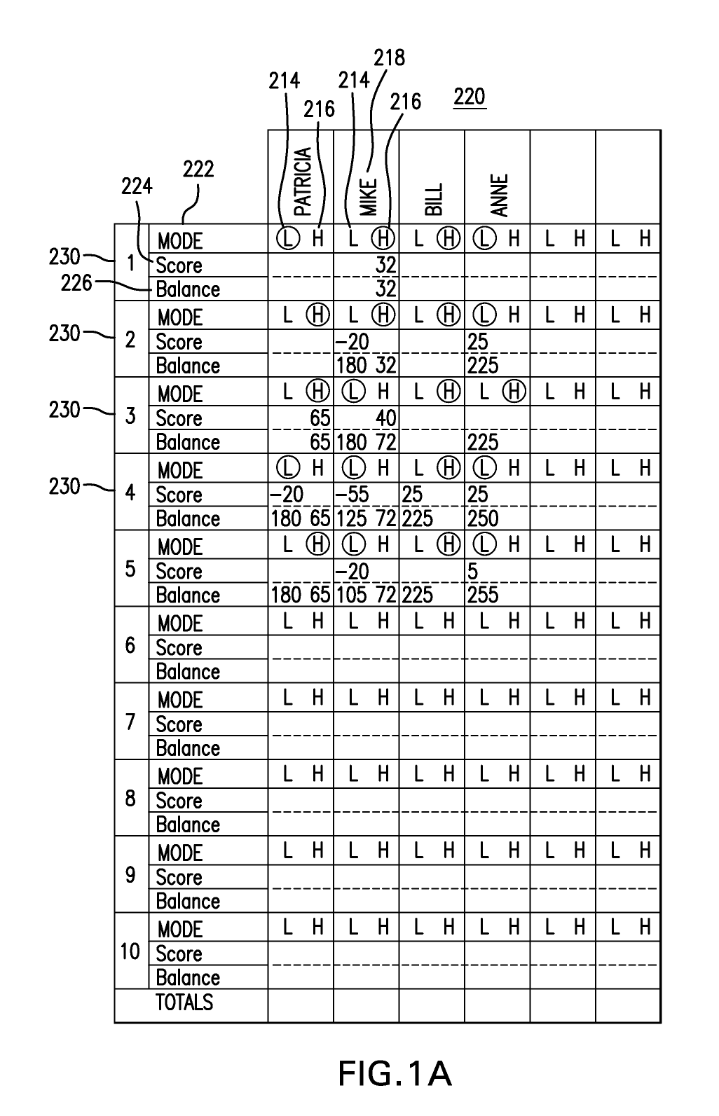

Reference is now made to FIGS. 1-24, wherein embodiments of the invention are exemplarily illustrated. Although the invention has been exemplarily illustrated by reference to specific embodiments, it will be apparent to those of ordinary skill in the art that various changes and modifications may be made which clearly fall within the scope of the invention. The invention is intended to be protected broadly within the spirit and scope of the appended claims.

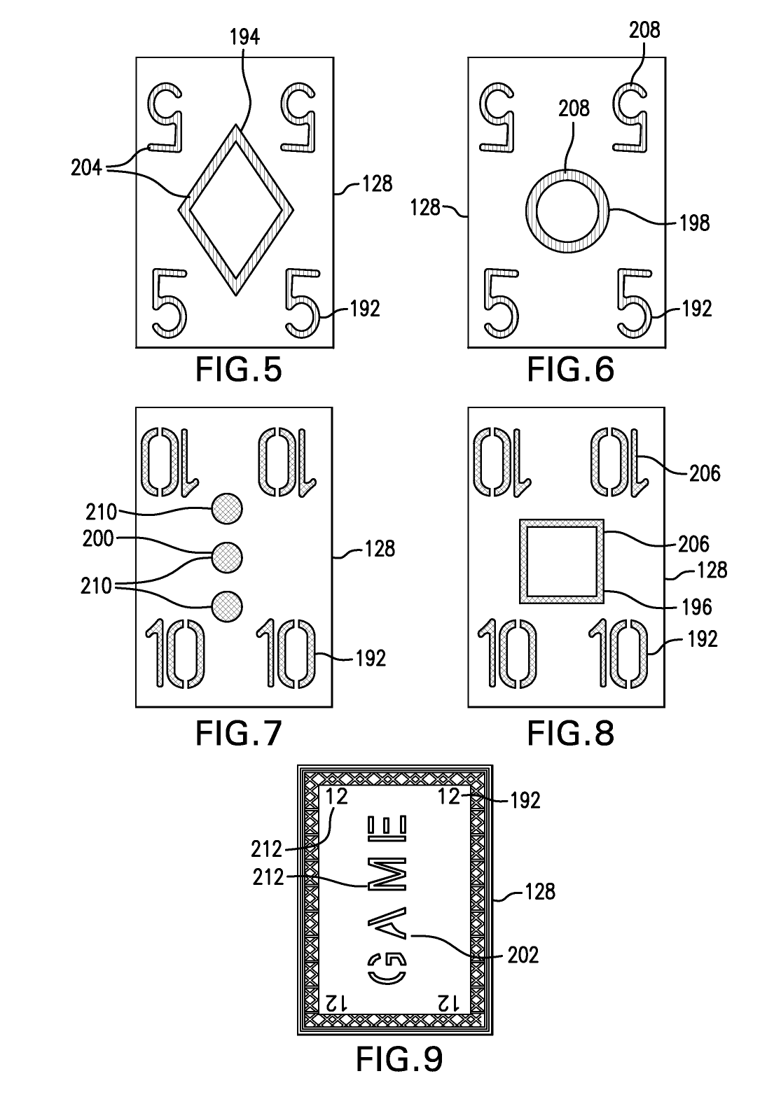

Referring now to FIGS. 5-9, representative cards 128 which comprise a deck of cards are illustrated. It is to be understood that the deck may be made of any of the physical materials currently known or to be discovered in the art for making a deck of cards and may include electronic representations of a deck of cards for use in conjunction with a machine currently known in the art, such as a computer, or to be discovered.

Some embodiments are played on a physical surface, such as but not limited to, a table. In other embodiments, the card game is played on one or more computing devices located at one or more homes or business establishments, or mobile computing devices, or in an online environment over a network such as the Internet. In some embodiments, when card games are played on computing devices, the computing devices generate visual representations of the components of the card game, as discussed herein, which are then displayed on a display device, such as a computer monitor, mobile device, or television screen, or projected by a video projector. Inputs are received from players through input devices coupled to the computing devices, such as a keyboard, a mouse, a touch sensitive display, a touch pad, or other input devices. In some embodiments, the actions of a dealer and/or one or more players are performed automatically by a computing device.

In some embodiments, the components of card game are physical objects. In other embodiments, the components are virtual representations of physical objects that are generated by a computing device.

In other embodiments, the card games can be played on one or more computing devices located at establishments or in an online environment over a network such as the Internet. In some embodiments, when card games are played on computing devices, the computing devices generate visual representations of physical playing cards that are, for example, displayed on a display device, such as a computer monitor or mobile device.

The card game of the present invention can be played live using one or more decks of conventional playing cards or it can be played in electronic or video form via video game machines, computers, mobile devices, and the like.

In some embodiments the deck of cards comprises 52 cards. Each deck includes one set of 12 cards having a first indicia, one set of 12 cards having a second indicia, one set of 12 cards having a third indicia, one set of 12 cards having a fourth indicia, and one set of 4 cards having a fifth indicia. However, it is to be understood that in some embodiments, the deck of cards could have more or less than 52 cards with a plurality of sets of cards, or in some embodiments four sets of equal numbers of cards and one set of cards with fewer cards than the other sets, as long as there were sufficient cards for each player to have at least 3 cards in the player's hands and there would be sufficient cards left over so that there would be enough cards in the master stack, which is explained in more detail below, to allow the players to play a plurality of hands before the discard stack, which is explained in more detail below, would have to be recycled. In some embodiments, there would be enough cards left over in the master stack to enable each player to be able to play nine hands while drawing from the master stack rather than from the discard stack before the discard stack would have to be recycled.

The card indicia can indicate point value designations 192. The point value designations for some indicia may be identical to the point value designations for other indicia, and the point value designations for some indicia must be different than the point value designations for other indicia.

In some embodiments, the point value designations for two of the indicia will be identical, the point value designations for two other of the indicia will be identical, and the point value designation for the remaining indicia will be different than the other four indicia.

In some embodiments the point value designation for two of the indicia will be ten points, the point value designations for two of the indicia will be five points, and the point value designation for the remaining indicia will be 12 points.

In addition, in some embodiments, the indicia can have color designations that can vary depending on the indicia. In some embodiments, the color designations for two of the indicia will be identical, the color designations for two other of the indicia will be identical, and the remaining indicia will not have a color designation.

In some embodiments the color designation for two of the indicia will be red, and the color designation for two of the indicia will be black, and the remaining indicia will not have a color designation.

In some embodiments the point value designation for the first indicia is five points, the point value designation for the second indicia is ten points, the point value designation for the third indicia is five points, the point value designation for the fourth indicia is ten points, and the point value designation for the fifth indicia is twelve points.

In some embodiments first indicia has a red color designation, the second in indicia has black color designation, the third indicia a red color designation, the fourth indicia has a black color designation and the fifth indicia does not have a color designation.

In some embodiments of a deck of cards the deck comprises a first indicia 194 that is at least one red diamond having a five point value, a second indicia 196 that is at least one black square having a ten point value, a third indicia 198 that is at least one red circle having a five point value, a fourth indicia 200 that is at least one black dot having a ten point value, and a fifth indicia 202 that is the word GAME having a twelve point value.

Specifically referring now to FIGS. 5-9 that illustrate a deck of cards comprising a first set of indicia 204 that is one red diamond and the number 5, a second set of indicia 206 that is one black square and a the number 10, a third set of indicia 208 that is one red circle and the number 5, a fourth set of indicia 210 that is three black dots and the number 10, and a fifth set of indicia 212 that is the word GAME and the number 12.

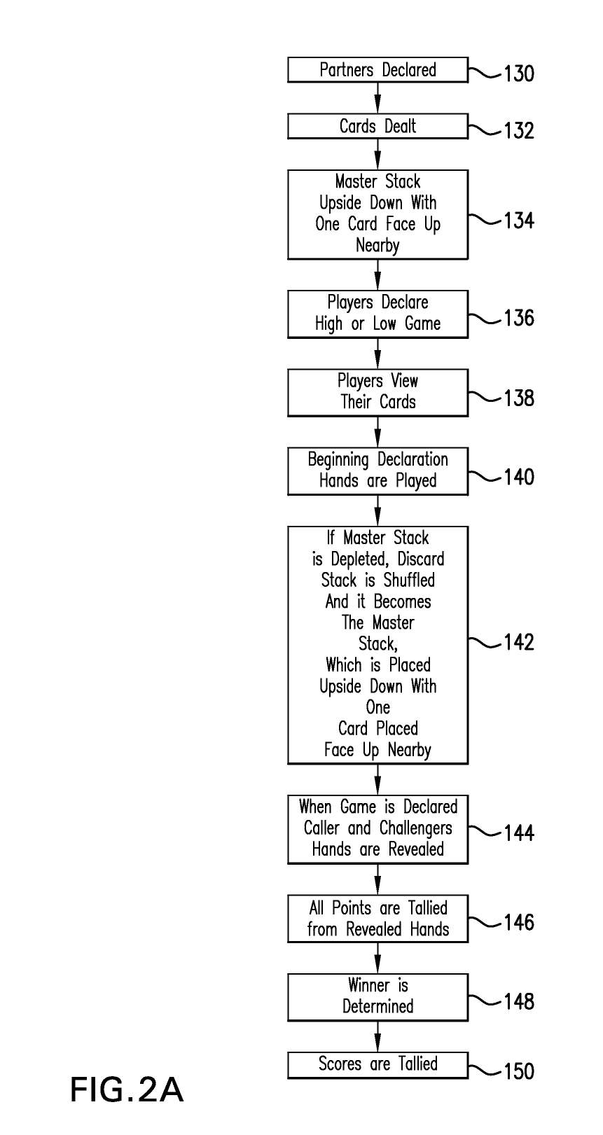

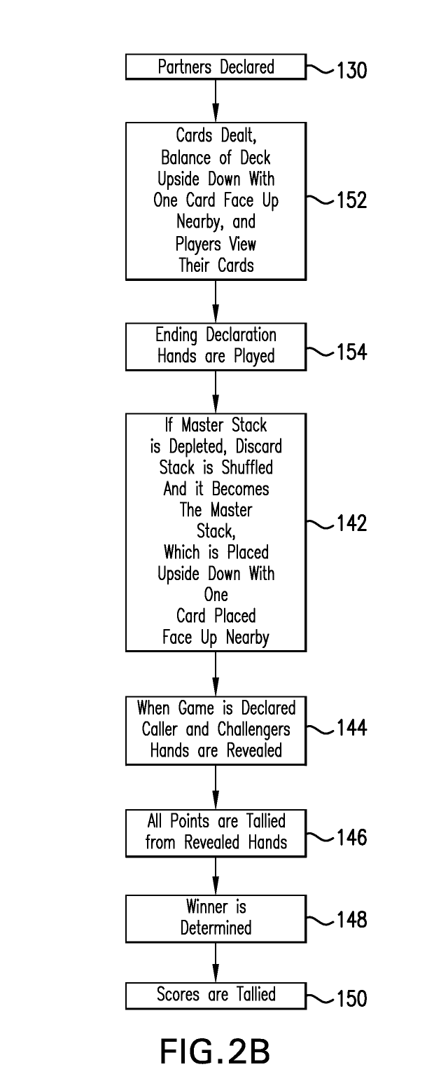

Referring now to FIGS. 2A-4 and 10-10-8, embodiments of a method for playing cards are exemplarily illustrated. Some embodiments of the method includes providing at least two players. It is to be understood that one or more of the players can be human beings or they can be electronic devices, such as but not limited to computers, currently known in the art or to be discovered that are specially programmable to play the card game of the current invention.

Each game includes at least one scoring segment, referred to as a “hand”. In some embodiments, as is explained in more detail below, the points from each hand are calculated until one player reaches a score that has been predetermined to be a winning score for the game. It is to be understood that a game can include more than one hand. In other embodiments, as is explained in more detail below, the game can last for a predetermined amount of time, and the score can be a tally of the points each player achieves during one or more hands during the predetermined amount of time. In other embodiments, each game can consist of one or more predetermined number of hands, and the score can be a tally of the points each player achieves during one or more hands during the predetermined amount of time. In computer-implemented embodiments, the “hands” of cards may be virtual groupings of cards that are displayed as graphical representations of the corresponding physical cards.

As known in the art, the dealer for more than one hand can rotate among the players. In some embodiments, the rotation of the dealer is predetermined by the players. In some embodiments, the dealer rotates in a clockwise direction among the players. In some embodiments, the dealer can remain the same person, player or entity for more than one hand. In computer-implemented embodiments, the “dealer” functionality may be implemented in software instead of by a human actor.

Reference is now made to FIG. 2A, which exemplarily illustrates the method for embodiments of a “Beginning Declaration” game. “Beginning Declaration” refers to the declaration of a high or low game, which is described in more detail below, during the beginning of the hand. Although, in some embodiments, this declaration is made by the player speaking a predetermined phrase to the other players, this declaration may alternatively be made in computer-implemented embodiments by way of user interaction with a computing device, such as a key press or button click, via a touchscreen interface (e.g., of a mobile computing device), or otherwise.

Before each hand is dealt, when there are at least three players the players have the opportunity to declare that they will be playing the hand as partners. See Block 130. To play as partners, two players have to declare themselves partners for a hand before that hand is dealt. When there are at least four players, there can be more than one set of partners, and there can be as many partners as the number of players allow. A player can only be partners with one other player for each hand. Not all players have to play as partners. A declaration of partnership made by players in connection with game play, as described herein, may be made either by spoken word, by user interaction with a computing device, or both, in like manner to a declaration of a high or low game.

In one embodiment, further rules for partners include the following, which will be explained in further detail below: Partners are required to declare if either will play High Game or Low Game, and partners do not have to play in the same mode as each other. When a player declares High Game, the player must have in their hand the most points compared to all the other players, including the player's partner. When a player declares Low Game, the player must have in their hand the fewest points compared to all the other players, including the player's partner.

Each player is dealt an equal number of random cards providing there are sufficient cards for each player to have at least 3 cards in each player's hands and for enough cards left to be over so that there are enough cards in the balance of the deck, which is referred to as the “master stack” to allow the players to play a plurality of hands before the discard stack, which is described in more detail below, will have to be recycled. See block 132. In some embodiments, there would be enough cards left over in the master stack to enable each player to be able to play nine hands while drawing from the master stack rather than from the discard stack before the discard stack would have to be recycled. The cards are dealt such that none of the players know what cards the other players have been dealt.

In some embodiments, each player is dealt four cards.

In some embodiments, each player is dealt four cards and the deck has 52 cards.

In some embodiments there are four players, each player is dealt four cards and the deck has 52 cards.

After the cards have been dealt to the players, the non-dealt cards, referred to as the “master stack” are placed face down such that they are accessible to all of the players, and one card from the master stack is placed face-up, near but not on top of the master stack, to start a discard stack such that all of the players can view the face-up card. See block 134. In some embodiments, the top card in the master deck is the card that is placed face up. In computer-implemented embodiments, the “stacks” of cards may be virtual stacks that are displayed as graphical representations of the corresponding physical cards.

When the game, which can be called “Beginning Declaration”, involves the declaration of high or low game, which are described in more detail below, at the beginning of the hand, the dealt cards remain face down and unknown to each player until each player declares whether that player is playing the hand in high game or low game. See block 136. Partners do not have to play in the same mode.

After declaring either High or Low Game, each player may then view the cards that they have been dealt in a manner whereby no player can see the contents of any other player's hand. See Block 138. Partners are not allowed to see each other's cards, and are not allowed to otherwise communicate to each other what cards they have or strategy they might be using. After announcing themselves to be partners for a hand, any time during the playing of the hand, if any partner (referred to as the “communicating partner” or “communicating partners”) tries to communicate to their partner about the cards in their hand or hands or their playing strategy for the hand, the communicating partner is or communicating partners are ineligible to play the remainder of the hand. In computer-implemented embodiments, partners may be prevented or limited from communicating with one another altogether to avoid this issue.

Each player plays his, her or its hand in a sequential order. The order may be any predetermined sequence. In some embodiments, the player to the left of the dealer will start playing his, her or its hand and each player in a clockwise rotation will play his, her or its hand next.

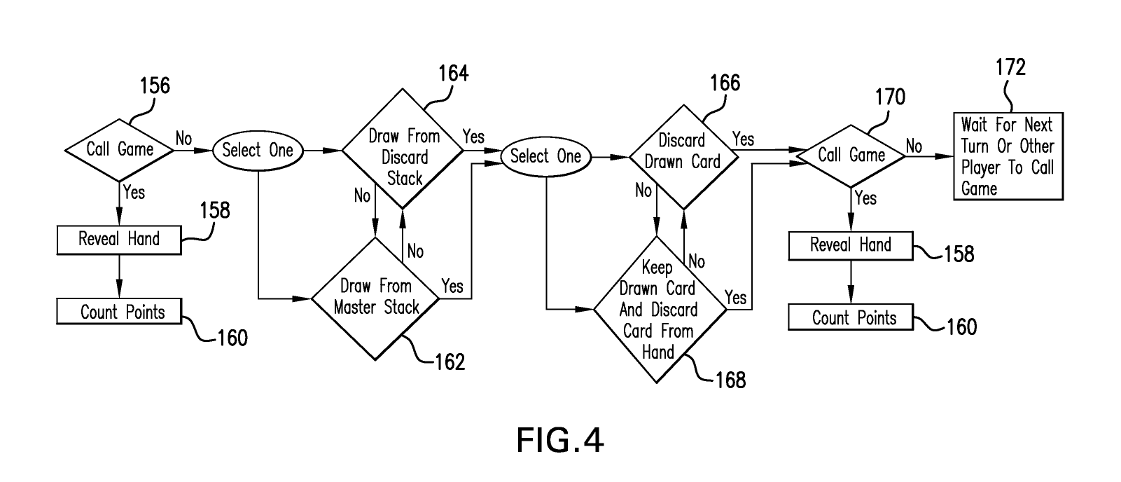

The hand is played according to the “Beginning Declaration” embodiment, see Block 140, as set forth in more detail below and as exemplarily illustrated in FIG. 4.

If during the playing of the hand the cards in the master stack become exhausted, and the player playing his, her or its hand does not want to draw the top discarded card, the discard stack will be shuffled and then placed face down on the playing area to create another master stack, while taking one card from the master stack and placing it face up to create another discard stack. See Block 142.

When a player declares game as described in more detail below, in addition to the caller, see FIG. 4, all players who challenge the caller as the winner reveal the cards in their hands. See block 144. The points in each individual revealed hand are tallied, see block 146, the point values are compared and the winner is determined. As described in more detail below, if a challenger has more points than the caller in a high game or if the challenger has fewer points than the caller in a low game, the challenger will be the winner, and is also referred to as the “real winner”. See block 148. Finally, the score or scores are tallied, see block 150, which is described in more detail below.

Reference is now made to FIG. 2B, which exemplarily illustrates the general method for an “Ending Declaration” game. “Ending Declaration” refers to the declaration of a High or Low Game during the end of the play of the hand and is described in more detail below.

Before each hand is dealt, when there are at least three players the players have the opportunity to declare partners. See block 130. To play as partners, two players have to declare themselves partners for a hand before that hand is dealt. When there are at least four players, there can be more than one set of partners, and there can be as many partners as the number of players allow. A player can only be partners with one other player for each hand. Not all players have to play as partners.

In one embodiment, further rules for partners include the following, which will be explained in further detail below: Partners are required to declare if either will play High Game or Low Game, and partners do not have to play in the same mode as each other. When a player declares High Game, the player must have in their hand the most points compared to all the other players, including the player's partner. When a player declares Low Game, the player must have in their hand the fewest points compared to all the other players, including the player's partner.

Each player is dealt an equal number of random cards providing there are sufficient cards for each player to have at least 3 cards in each player's hands and for enough cards left to be over so that there are enough cards in the balance of the deck, which is referred to as the “master stack” to allow the players to play a plurality of hands before the discard stack will have to be recycled. In some embodiments, there would be enough cards left over in the master stack to enable each player to be able to play nine hands while drawing from the master stack rather than from the discard stack before the discard stack would have to be recycled. The cards are dealt such that the other at least one player is not does not know what are the other at least one player's cards.

In some embodiments, each player is dealt four cards.

In some embodiments, each player is dealt four cards and the deck has 52 cards.

In some embodiments there are four players, each player is dealt four cards and the deck has 52 cards.

After the cards have been dealt to the players, the non-dealt cards, referred to as the “master stack” are placed face down such that they are accessible to all of the players, and one card from the master stack is placed face-up, near but not on top of the master stack, to start a discard stack such that all of the players can view the face-up card. In some embodiments, the top card in the master deck is the card that is placed face up. In computer-implemented embodiments, the “stacks” of cards may be virtual stacks that are displayed as graphical representations of the corresponding physical cards.

Each player may immediately view the cards that they have been dealt in a manner whereby no player can see the contents of any other player's hand. See block 152. Partners are not allowed to see each other's cards, and are not allowed to otherwise communicate to each other what cards they have or strategy they might be using. After announcing themselves to be partners for a hand, any time during the playing of the hand, if any partner (referred to as the “communicating partner” or “communicating partners”) tries to communicate to their partner about the cards in their hand or hands or their playing strategy for the hand, the communicating partner is or communicating partners are ineligible to play the remainder of the hand. In computer-implemented embodiments, partners may be prevented or limited from communicating with one another altogether to avoid this issue.

Each player plays his, her or its hand in a sequential order. The order may be any predetermined sequence. In some embodiments, the player to the left of the dealer will start playing his, her or its hand and each player in a clockwise rotation will play his, her or its hand next.

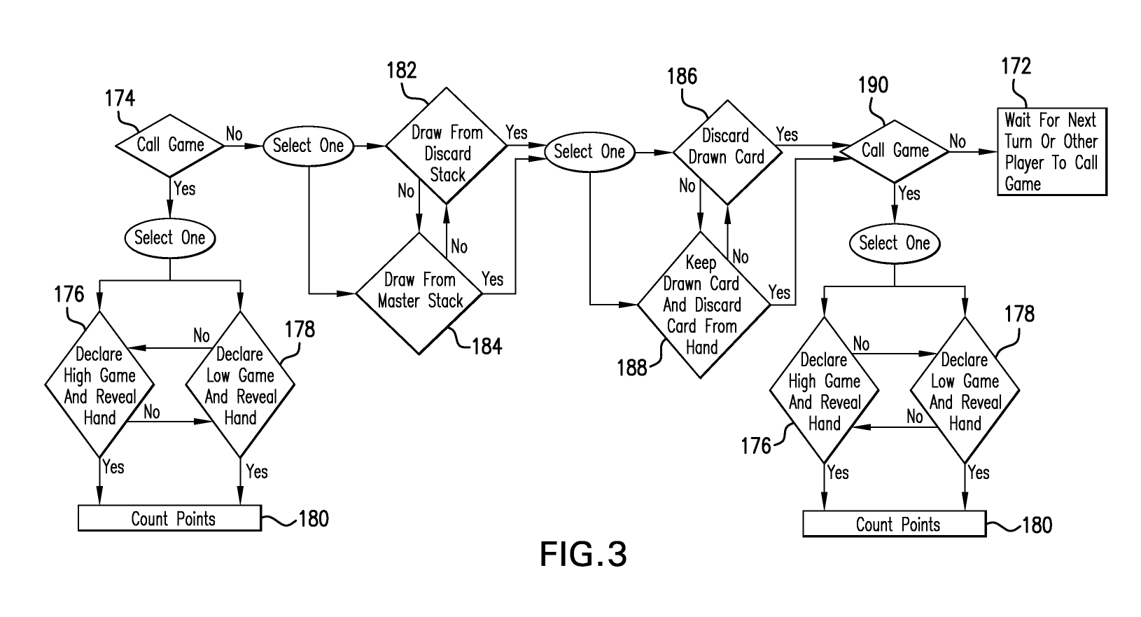

The hand is played according to the “Ending Declaration” embodiment, see block 154, as exemplarily set forth in more detail below and as illustrated in FIG. 3.

If during the playing of the hand the cards in the master stack become exhausted, and the player playing his, her or its hand does not want to draw the top discarded card, the discard stack will be shuffled and then placed face down on the playing area to create another master stack, while taking the one card from the master stack and placing it face up to create another discard stack. See Block 142. In some embodiments, the top card in the master deck will be the face-up card.

When a player declares game as described in more detail below, in addition to the caller, see FIG. 3, all players who challenge the caller as the winner reveal the cards in their hands. See block 144. The points in each individual revealed hand are tallied, see block 146, the point values are compared and the winner is determined. As described in more detail below, if a challenger has more points than the caller in a high game or if the challenger has fewer points than the caller in a low game, the challenger will be the winner, and is also referred to as the “real winner”. See block 148. Finally, the score or scores are tallied, see block 150, which is described in more detail below. In computer-implemented embodiments, the tallying of points and scoring may be automatically effected by software instead of being manually performed by the players themselves.

Reference is now made to FIG. 4, which exemplarily illustrates each player's options when playing a hand in a Beginning Declaration game. Initially, the player can decide whether or not the player wants to call an end to the hand. In some embodiments, the declaration of the end of the hand is in the form of the player declaring the word “game”. Declaring the end of the hand will be referred to as “calling game” whether or not the player actually uses the word “game.” See block 156. The player who calls game will be called the “caller” herein. If the player decides to call game, the caller must reveal the contents of his, her or its hand. See block 158. In some embodiments, the disclosure is done by the caller laying down his, her or its cards face up. In addition, the points in the caller's hand will be counted. See block 160. (Thereafter, as illustrated in block 144 in FIG. 2A any challengers to the caller being the winner will also reveal his, her or its hand.) Although, in some embodiments, the “calling game” declaration is made by the player speaking a predetermined phrase to the other players, this declaration may alternatively be made in computer-implemented embodiments by way of user interaction with a computing device, such as a key press or button click, via a touchscreen interface (e.g., of a mobile computing device), or otherwise.

If the player decides not to call game, the player must draw one card. The player must decide whether to draw either the top card from the master stack, see block 162, or the top card on the discard stack, see block 164.

A player cannot have more than the dealt number of cards in his, her or its hand. In some embodiments, when four cards are dealt, a player cannot have more than four cards in his, her or its hand. After the player draws a card, the player may keep the drawn card or may discard the drawn card. If the player keeps the drawn card, the player must discard one of the cards that was already in the player's hand before having drawn the drawn card. See blocks 166 and 168. The discarded card is placed face up on the top of the discard stack.

After discarding a card and before the next player either calls game or draws a card from the master stack or from the discard stack, again the player can decide whether or not the player wants to call game. See block 170. If the player decides to call game, the caller must reveal the contents of the caller's hand. See block 158. In some embodiments, the disclosure is done by the caller laying down his, her or its cards face up. In addition, the points in the caller's hand will be counted. See block 160. (Thereafter, as illustrated in block 144 in FIG. 2A any challengers to the caller being the winner will also reveal his, her or its hand.)

If the player does not call game after discarding a card and before the next player either calls game or draws a card from the master stack or from the discard stack, the player must then wait to have an opportunity to play his, her or its hand again until the player's turn comes up again in sequential order, unless another player calls game in the interim and thereby ends the hand. See block 172.

Reference is now made to FIG. 3, which exemplarily illustrates each player's options when playing a hand in an Ending Declaration game. Initially, the player can decide whether or not the player wants to call an end to the hand. In some embodiments, the declaration of the end of the hand is in the form of the player declaring the word “game”. Declaring the end of the hand will be referred to as “calling game” whether or not the player actually uses the word “game.” See block 174. The player who calls game will be called the “caller” herein. If the player decides to call game, that player, referred to at the “caller” must also commit to and disclose whether the caller is declaring a high game or a low game and the caller must reveal the cards in the caller's hand. See blocks 176 and 178. In some embodiments, the disclosure is done by the caller laying down his, her or its cards face up. In addition, the points in the caller's hand will be counted. See block 180. (Thereafter, as illustrated in block 144 in FIG. 2B any challengers to the caller being the winner will also reveal his, her or its hand.) Although, in some embodiments, the “calling game” declaration is made by the player speaking a predetermined phrase to the other players, this declaration may alternatively be made in computer-implemented embodiments by way of user interaction with a computing device, such as a key press or button click, via a touchscreen interface (e.g., of a mobile computing device), or otherwise.

If the player decides not to call game, the player must draw one card. The player must decide whether to draw either the top card from the master stack or the top card on the discard stack. See blocks 182 and 184.

A player cannot have more than the dealt number of cards in his, her or its hand. In some embodiments, when four cards are dealt, a player cannot have more than four cards in his, her or its hand. After the player draws a card, the player may keep the drawn card or may discard the drawn card. If the player keeps the drawn card, the player must discard one of the cards that was already in the player's hand before having drawn the drawn card. See blocks 186 and 188. The discarded card is placed face up on the top of the discard stack.

After discarding a card and before the next player either calls game or draws a card from the master stack or from the discard stack, again the player can decide whether or not the player wants to call game. See block 190. If the player decides to call game, that player, referred to at the “caller” must also commit to and disclose whether the caller is declaring a high game or a low game and the caller must reveal the cards in the caller's hand. See blocks 176 and 178. In some embodiments, the disclosure is done by the caller laying down his, her or its cards face up. In addition, the points in the caller's hand will be counted. See block 180. (Thereafter, as illustrated in block 144 in FIG. 2B any challengers to the caller being the winner will also reveal his, her or its hand.) Although, in some embodiments, the “calling game” declaration is made by the player speaking a predetermined phrase to the other players, this declaration may alternatively be made in computer-implemented embodiments by way of user interaction with a computing device, such as a key press or button click, via a touchscreen interface (e.g., of a mobile computing device), or otherwise.

If the player does not call game after discarding a card and before the next player either calls game or draws a card from the master stack or from the discard stack, the player must then wait to have an opportunity to play his, her or its hand again until the player's turn comes up again in sequential order, unless another player calls game in the interim and thereby ends the hand. See block 172

When determining the winner and scoring a hand, generally, if the caller has declared a low game, the caller will win the hand if the sum of the points in the caller's hand is lower than the individual sums of the points in the other player's hands; for purposes of description, the caller in such a situation can be called the “winner”. However, if another player has fewer points in his, her or its hand than the caller, then the player with the least number of points in his, her or its hand is the winner of the hand; for purposes of description, the player with the least number of points in his, her or its hand in such a situation can be called the “winner” or the “real winner”. Similarly, if the caller has declared a high game, the caller will win the hand if the sum of the points in the caller's hand is higher than the individual sums of the points in the other player's hands; for purposes of description, the caller in such a situation can be called the “winner”. However, if another player has more points in his, her or its hand than the caller, then the player with the most number of points in his, her or its hand is the winner of the hand; for purposes of description, the player with the most number of points in his, her or its hand in such a situation can be called the “winner” or the “real winner”. In computer-implemented embodiments, the notification of being a “winner” and/or “real winner” may be made automatically through software and provided to a user via a display.

During the course of the game, unless the game consists of only one hand, the score of the players can be tallied in both a high game tally and a low game tally. For each hand, depending on whether the caller declares a high game or a low game, the tally will be either under the high game tally or the low game tally. Specifically, if the caller declares a high game, the winner will have his, her or its points added to his, her or its High Game tally. If the caller declares a low game, the winner will have his, her or its points subtracted from his, her or its Low Game tally. And if the caller is not the winner, the caller will have the caller's points added to the caller's Low Game tally if low game was declared and the caller will have the caller's points subtracted from the caller's High Game tally if high game was declared.

In some embodiments, bonus points can be added to the winner's points for specific types of card combinations. In some embodiments, bonus points can be added if the winner has cards that are all the same color. In some embodiments, bonus points can be added if the winner has all red cards or all black cards. In some embodiments, 25 bonus points can be added if the winner has all black cards. In some embodiments, 10 bonus points can be added if the winner has all red cards. In some embodiments, 25 bonus points can be added if the winner has all black cards and no Game cards. In some embodiments, 10 bonus points can be added if the winner has all red cards and no Game cards.

It is to be noted that the points in the hands are determined by counting the points designated to the various cards in the deck. In some embodiments, the points 192 are listed on the face of the cards, as illustrated in FIGS. 5-9. In some embodiments, the point designations of the cards will be determined in some other manner and/or agreed upon by the players in some other manner before playing the hand.

In some embodiments, the tally for a high scoring game starts at zero points, and the tally for a low scoring game starts at 200 points. In some embodiments, the winner of a game is the first player to accumulate 400 points from a starting point of zero in the high game scoring tally or the first player to have all 200 points deducted in the low game scoring tally. In another similar embodiment, the winner of the game is the player who is closest to either 400 high game points or zero low game points when the game ends (such as when time runs out or when a designated number of hands have been played.) For example, if one player has 10 low game points and another player has 380 high game points, the player with 10 low game points would win the game.

In some embodiments, the player who has had the most points added to or subtracted from the player's tally when have the game ends (such as when time runs out or when a designated number of hands been played) is the winner of the game. For example if one player has added 100 points in the high game tally and has subtracted 199 points in the low game tally, and no other player has either added or subtracted more than 198 points, the player who has subtracted 199 points is the winner of the game. In another similar embodiment, the player who has had the most total points added to or subtracted from the player's tally when the game ends (such as when time runs out or when a designated number of hands have been played) is the winner of the game. For example if one player has added 100 points in the high game tally and has subtracted 199 points in the low game tally, and no other player has either added or subtracted more than 298 points, the player who has added 100 points and subtracted 199 points is the winner of the game.

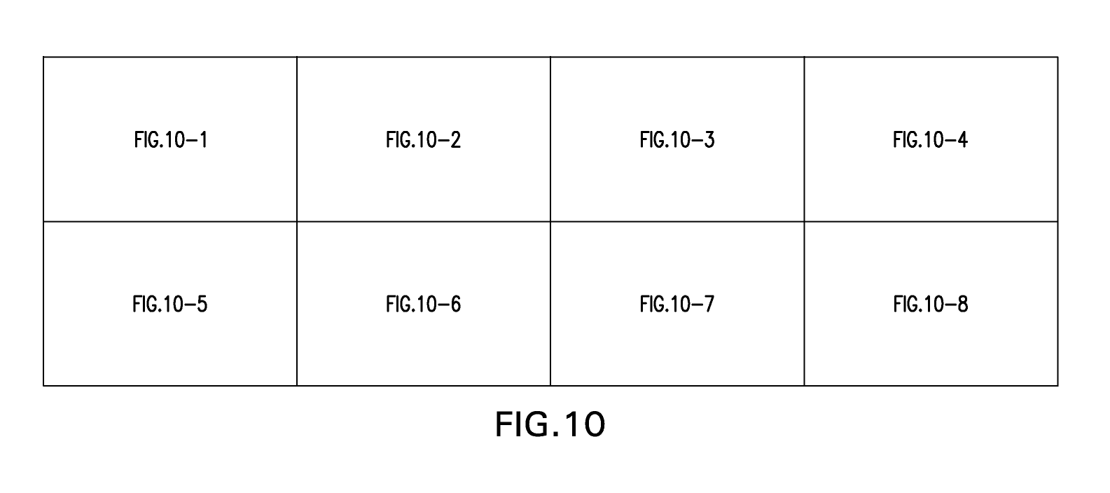

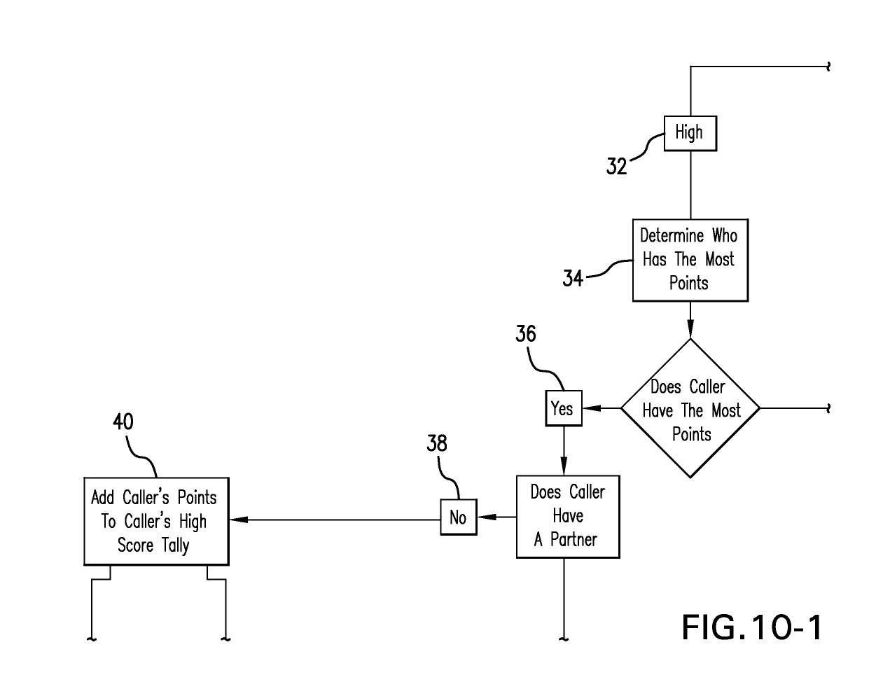

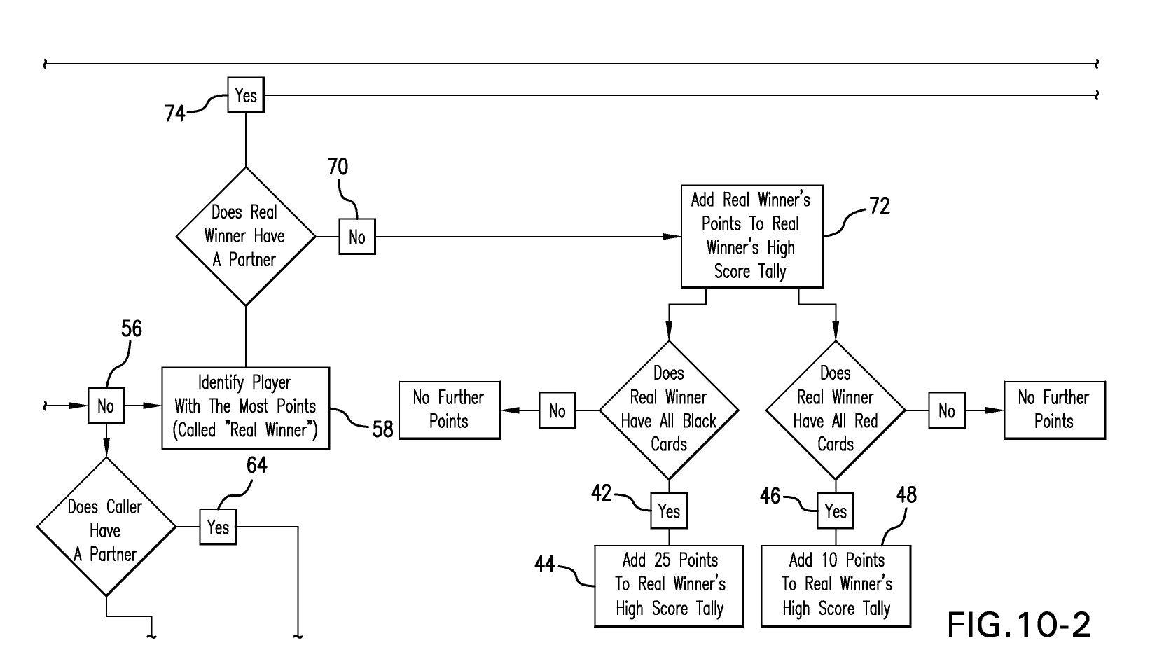

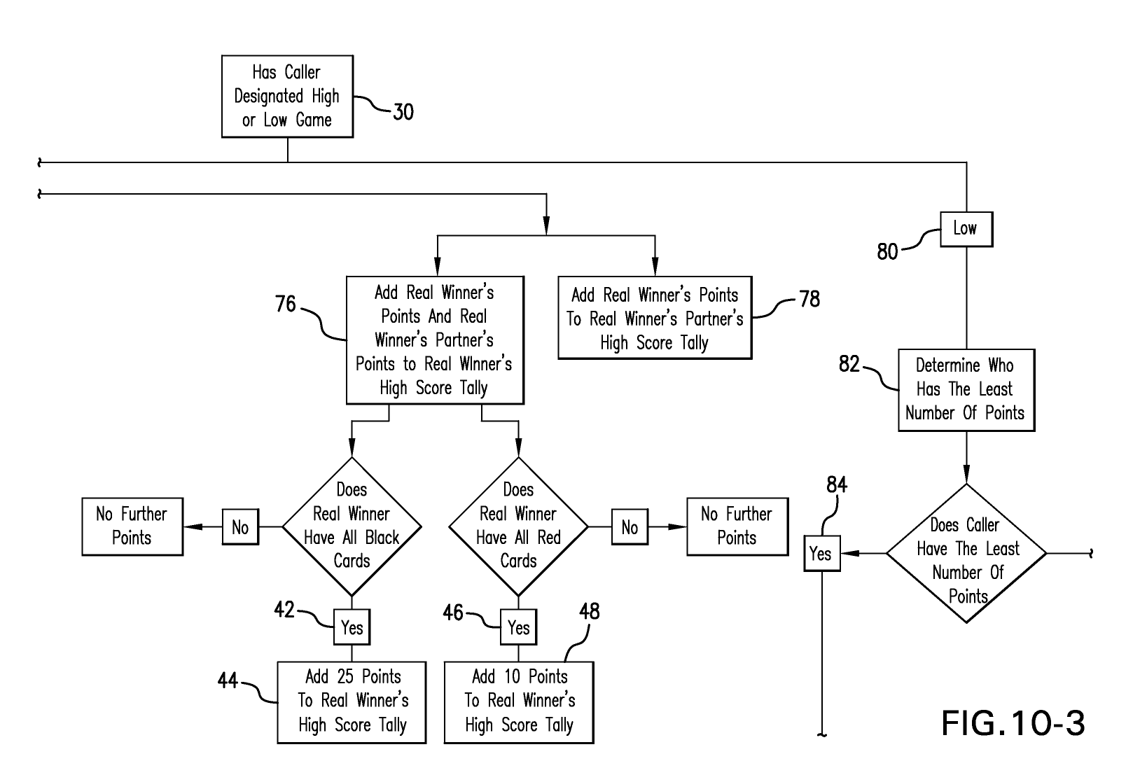

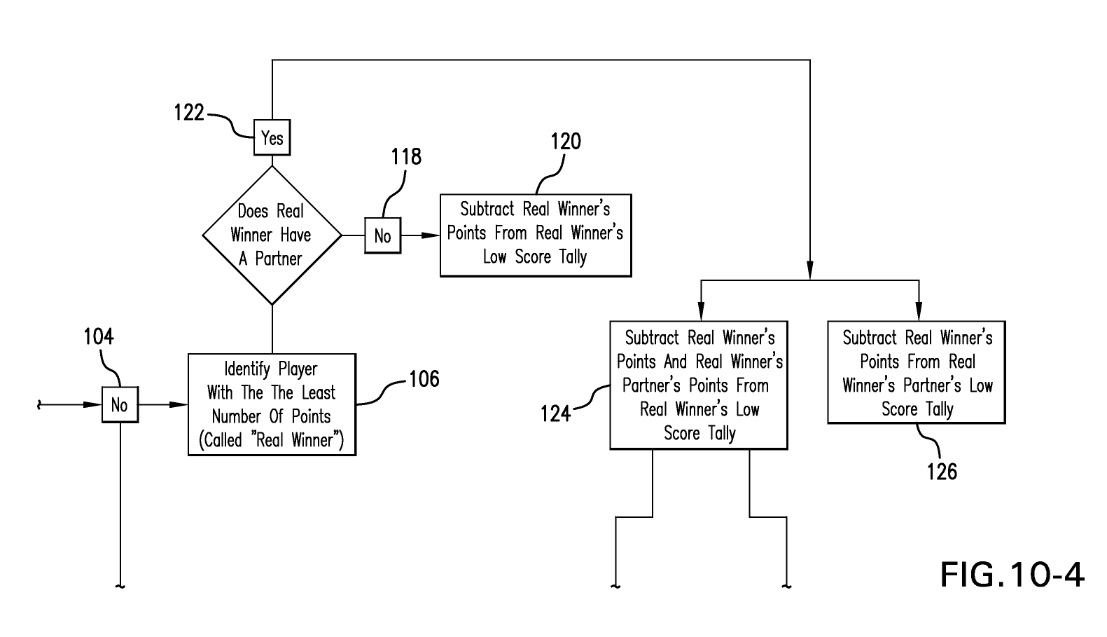

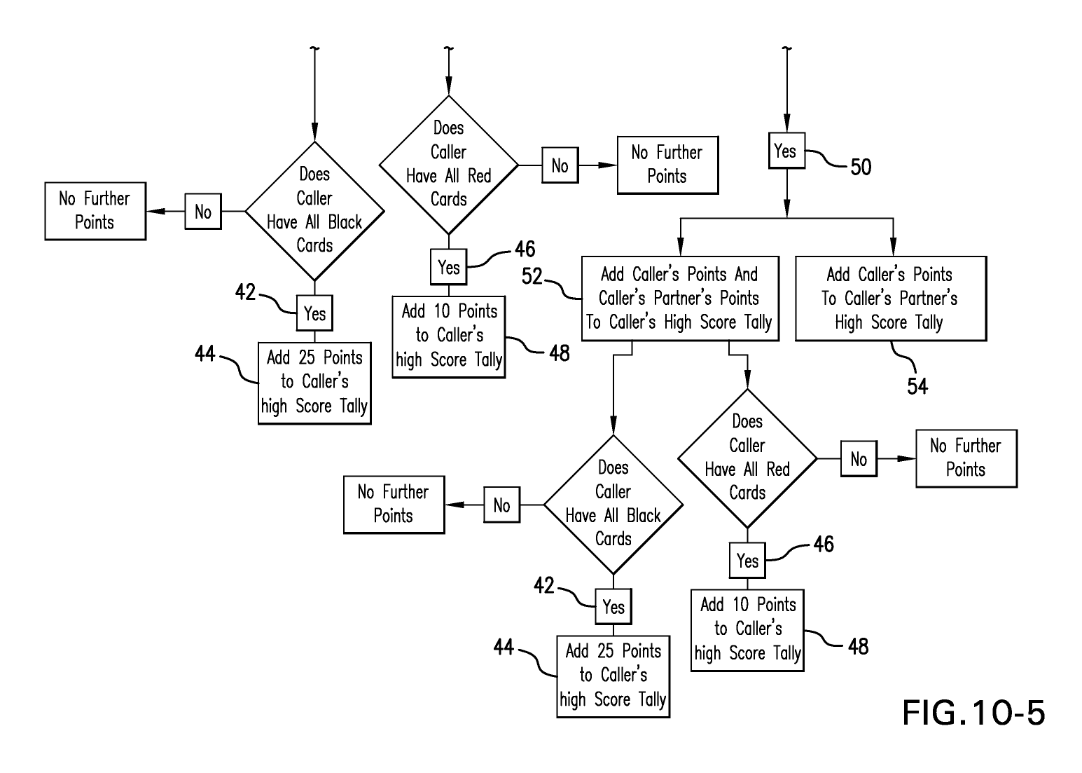

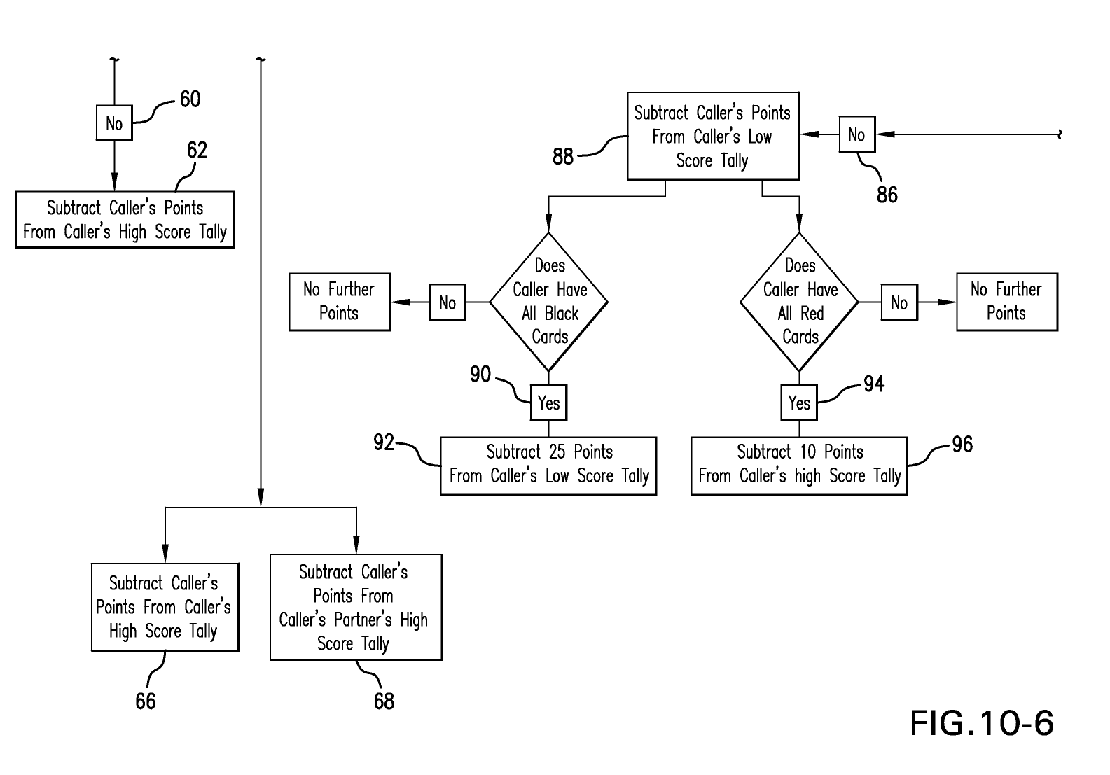

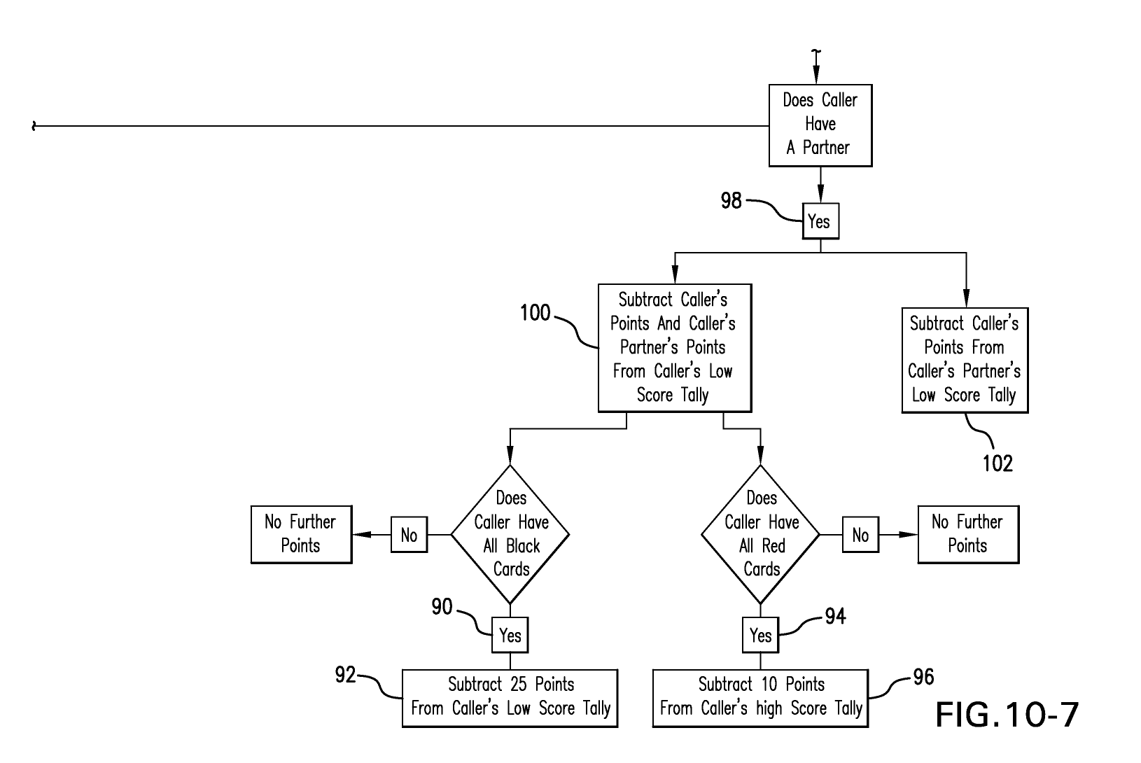

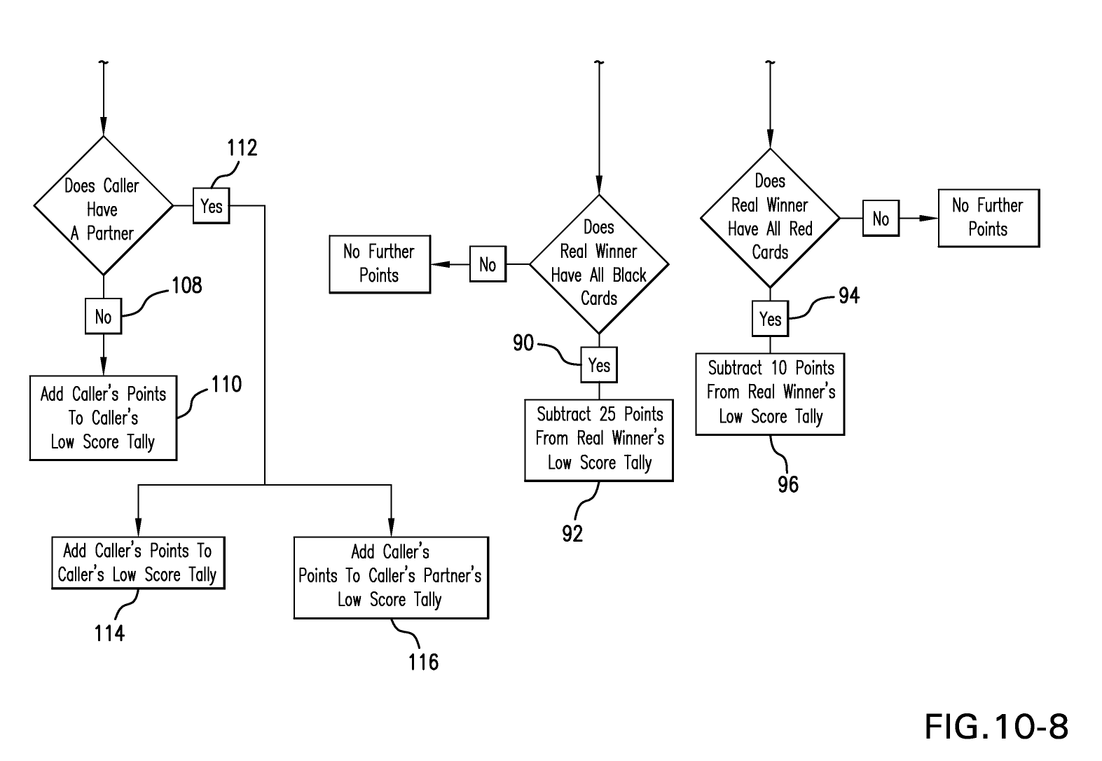

Reference is now made to FIG. 10-10-6, which exemplarily illustrates the scoring method in embodiments of the invention and further describes the relevance of the players' declarations of a high or low game. In addition, reference is made to FIG. 1, which exemplarily illustrates an exemplary scorecard 220 that can be used with the embodiments of the method of the current invention. Scorecard 220 may be a paper or other manually-kept scorecard, or, in computer-implemented embodiments, may be provided as a graphical representation on a computer display of a scorecard that is automatically updated and provided via software.

Referring now to FIG. 1, an embodiment of a score sheet 220 for scoring embodiments of the game of the invention is exemplarily illustrated. It is to be understood that other types of scoring sheets, displays and tally methods can be used. Specifically referring to FIG. 1, it may be seen that there is a low 214, which can be designated as “L” and a high 216, which can be designated as “H”, column for each player. Further there is a “Mode” 222, “Score” 224 and “Balance” 226 column for each hand that is played. As is described in more detail below, the Mode column designates the mode each player has selected for each hand 230; which can be either Low Game, which can be designated by “L” or High Game, which can be designated by “H”. It is to be noted that if a Beginning Declaration game is being played all of the players will declare whether they will be playing a High Game or a Low Game before viewing their cards. In this embodiment, the High or Low Game designations can be indicated on the score card by circling the H or L for each player for each hand, as illustrated in FIG. 1. However, if an Ending Declaration Game is being played, only the caller will declare High Game or Low Game when calling Game, and only the caller (not shown on FIG. 1) will have the H or L circled on the score sheet for that hand.

In addition on the score sheet, there is a score column that records the score of the player for each hand if the player actually receives a score for the hand 230 in question. Further, there is a balance column that tallies the score of the player from hand to hand. It is to be noted that if a single player wins or loses some High Game hands and some Low Game hands, that player will have a score both under the Low “L” column and a separate score under the High “H” column for one game.

Referring also now to FIG. 10-10-8, to score the game, the initial determination is whether the caller has designated High or Low Game. See Block 30.

If the caller has designated High Game 32, the next step is to determine if the caller has the most points in the caller's hand or if another player has the most points in his, her or its hand 34.

If the caller has the most points 36, and the caller does not have a partner 38, the caller receives all of the points in the caller's hand 40 under the caller's High Game tally. In addition, if the caller has all black cards 42, and does not have a Game Card, the caller receives an additional 25 points in the caller's High Game tally 44. Further if the caller has all red cards 46, and does not have a Game Card, the caller receives an additional 10 points in the caller's High Game tally 48.

If the caller has the most points, and the caller does have a partner 50, the caller receives all of the points in the caller's hand and all the points in the caller's partner's hand in the caller's High Game tally 52. In addition, if the caller has all black cards 42, and does not have a Game Card, the caller receives an additional 25 points in the caller's High Game tally 44. Further if the caller has all red cards 46, and does not have a Game Card, the caller receives an additional 10 points in the caller's High Game tally 48.

If the caller has the most points, and the caller has a partner, the caller's partner receives all of the points in the caller's hand in the caller's partner's High Game tally 54 for that hand.

If the caller does not have the most points 56, the player with the most points is identified, which will be called the “real winner” herein 58. If the caller does not have a partner 60, the caller has all of the points in the caller's hand subtracted under the caller's High Game tally 62.

If the caller does not have the most points 56, and the caller has a partner 64, the caller has all of the points in the caller's hand subtracted under the caller's High Game tally.

If the caller does not have the most points 56, and the caller has a partner, the caller's partner has all of the points in the caller's hand subtracted under the caller's partner's High Game tally 68.

If the real winner does not have a partner 70, the real winner receives all of the points in the real winner's hand in the real winner's High Game tally 72. In addition, if the real winner has all black cards 42, and does not have a Game Card, the real winner receives an additional 25 points in the real winner's High Game tally 44. Further if the real winner has all red cards 46, and does not have a Game Card, the real winner receives an additional 10 points in the real winner's High Game tally 48.

If the real winner has a partner 74, the real winner receives all of the points in the real winner's hand and all the points in the real winner's partner's hand in the real winner's High Game tally 76. In addition, if the real winner has all black cards 42, and does not have a Game Card, the real winner receives an additional 25 points in the real winner's High Game tally 44. Further if the real winner has all red cards 46, and does not have a Game Card, the real winner receives an additional 10 points in the real winner's High Game tally 48. In addition, the real winner's partner receives all of the points in the real winner's hand under the real winner's partner's High Game tally 78 for that hand.

If the caller has designated Low Game 80, the next step is to determine if the caller has the least number of points in the caller's hand or if another player has the least number of points in his, her or its hand 82.

If the caller has the least number of points 84, and the caller does not have a partner 86, the caller subtracts all of the points in the caller's hand under the caller's Low Game tally 88. In addition, if the caller has all black cards 90, and does not have a Game Card, the caller subtracts an additional 25 points in the caller's Low Game tally 92. Further if the caller has all red cards 94, and does not have a Game Card, the caller subtracts an additional 10 points in the caller's Low Game column 96.

If the caller has the least number of points, and the caller has a partner 98, the caller subtracts all of the points in the caller's hand and all the points in the caller's partner's hand under the caller's Low Game tally 100. In addition, if the caller has all black cards 90, and does not have a Game Card, the caller subtracts an additional 25 points in the caller's Low Game tally 92. Further if the caller has all red cards 94, and does not have a Game Card, the caller subtracts an additional 10 points in the caller's Low Game column 96.

If the caller has the least number of points, and the caller has a partner 98, the caller's partner subtracts all of the points in the caller's hand under the caller's partner's Low Game tally 102 for that hand.

If the caller does not have the least number of points 104, the player with the least number of points is identified, which will be called the “real winner” herein 106. If the caller does not have a partner 108, the caller has all of the points in the caller's hand added to the caller's Low Game tally 110.

If the caller does not have the least number of points 104, and the caller has a partner 112, the caller has all of the points in the caller's hand added to the caller's Low Game tally 114.

If the caller does not have the least number of points 104, and the caller has a partner, the caller's partner has all of the points in the caller's hand added to the caller's partner's Low Game tally for that hand 116.

If the real winner does not have a partner 118, the real winner subtracts all of the points in the real winner's hand under the real winner's Low Game tally 120. In addition, if the real winner has all black cards 90, and does not have a Game Card, the real winner subtracts an additional 25 points in the real winner's Low Game tally 92. Further if the real winner has all red cards 94, and does not have a Game Card, the real winner subtracts an additional 10 points in the real winner's Low Game tally 96.

If the real winner has a partner 122, the real winner subtracts all of the points in the real winner's hand and all the points in the real winner's partner's hand under the real winner's Low Game tally 124. In addition, if the real winner has all black cards 90, and does not have a Game Card, the real winner subtracts an additional 25 points in the real winner's Low Game tally 92. Further if the real winner has all red cards 94, and does not have a Game Card, the real winner subtracts an additional 10 points in the real winner's Low Game tally 96. In addition, the real winner's partner subtracts all of the points in the real winner's hand under the real winner's partner's Low Game tally 126 for that hand.

The following list will further describe the scoring embodiments for the invention based on the following usage of the following terms: 1) “winner” is the real winner, and the caller when the caller calls high game and has the most points in the caller's hand or when the caller calls low game and has the fewest points in the caller's hand; 2) “the player who erroneously declared game” is the caller when the caller calls high game and the caller does not have the most points in the caller's hand or when the caller calls low game and the caller does not have the fewest points in the caller's hand.

1. Non-partner High Game scoring:
A. The winner will be credited with the value of the cards in their own hand.
B. The player who erroneously declared Game will have a deduction in their score equal to the value of the cards in their hand.
C. There is no score for the other players.

2. Non-partner Low Game scoring:
A. The winner will have the points in their hand deducted from their pool of points, which in some embodiments starts at 200 points.
B. The player who erroneously declared Game will have the points in their hand added to their pool of points, which in some embodiments starts at 200 points.
C. There is no score for the other players.

3. Partner High Game Scoring:
A. The winner will be credited with the points in their hand plus those in the partner's hand.
B. The partner is credited with the winner's points only.
C. The player who erroneously declared Game will have a deduction in their score equal to the value of the cards in their hand.
D. The partner of the player who erroneously declared Game will have a deduction in their score equal to the value of the cards in the player who erroneously declared Game's hand.

4. Partner Low Game Scoring:
A. The winner will have the points in their hand plus those in their partner's hand deducted from their pool of points, which in some embodiments starts at 200 points.
B. The partner will have only the points in the winner's hand deducted from their pool of points, which in some embodiments starts at 200 points.
C. The player who erroneously declared Game will have the points in their hand added to their pool of points, which in some embodiments starts at 200 points.
D. The partner of the player who erroneously declared game will have the value of the points in the hand of the player who erroneously declared Game added to their pool of points, which in some embodiments starts at 200 points.

Reference is now made to FIG. 1A, which exemplarily illustrates a score sheet for five exemplary fictional hands, where the Low Game tally starts at 200 points and wins at zero and the High Game tally starts at zero and wins at 400, as follows:

1. First Hand: Mike calls High Game. Mike has the most points in his hand, which are 32 points. Mike receives 32 points in the High Game tally. None of the other players receives any points.
2. Second Hand: Ann calls Low Game. Ann has 25 points in her hand and Mike has the least number of points, 20 points, in his hand. Ann has 25 points added to her Low Game tally and Mike has 20 points subtracted from his Low Game tally. None of the other players receives any points.
3. Third Hand: Patricia and Mike are partners. Patricia calls High Game and has the most points, 40 points, in her hand. Mike has 25 points in his hand. Patricia gets the value of the points in her hand and in Mike's hand added to her High Game tally. Patricia gets 65 points added to her High Game tally. Mike gets the value of Patricia's hand, 40 points, added to his High Game tally. Since Mike already had 32 points in his High Game tally, his new High Game balance is 72.
4. Fourth Hand: Bill and Ann are partners and Patricia and Mike are partners. Ann calls Low Game. Mike has the fewest points in his hand, at 20 points. The following players have the following points: Patricia has 35 points, Ann has 25 points and Bill has 30 points. Mike has the value of his hand and the value of Patricia's hand subtracted from his Low Game tally. Mike has 55 points subtracted from his low game tally. Since he had 20 points subtracted in a previous hand, Mike's Low Game balance from a starting point of 200 points is 125. Patricia has the value of Mike's hand, 20 points, subtracted from her Low Game tally. Ann and Bill both have the value of the points in Ann's hand added to their respective Low Game tallies.
5. Fifth Hand: Ann and Mike are partners and Patricia and Bill are partners. Ann calls Low Game. Mike has the fewest points in his hand, at 20 points. The following players have the following points: Patricia has 35 points, Ann has 25 points and Bill has 30 points. As the player that erroneously called Game, Ann has the value of her hand added her Low Game tally, but as the partner of the real winner, Mike, Ann also has the value of the points in Mike's hand, 20 points, subtracted from her Low Game tally. Ann's net point change in her Low Game tally is the addition of five points. Mike, as the real winner, gets the value of the points in his hand, 20 points, and the value of the points in his partner Ann's hand, 25 points, subtracted from his Low Game tally. However, because he is also the partner of the player who erroneously called Game, he also has the value of Ann's hand, 25 points, added to his Low Game tally. Mike's net point change in his Low Game tally is the subtraction of 20 points.

One embodiment of the invention is as follows: The deck of cards comprises 52 cards. Each deck includes one set of 12 cards having a first indicia, one set of 12 cards having a second indicia, one set of 12 cards having a third indicia, one set of 12 cards having a fourth indicia, and one set of 4 cards having a fifth indicia. Specifically as exemplarily illustrated in FIGS. 5-9 a deck of cards comprises a first set of indicia 204 that is one red diamond and the number 5, a second set of indicia 206 that is one black square and a the number 10, a third set of indicia 208 that is one red circle and the number 5, a fourth set of indicia 210 that is three black dots and the number 10, and a fifth set of indicia 212 that is the word GAME and the number 12. There are four players, each player is dealt four cards from the deck. The dealer rotates between the players in a clockwise rotation. The player to the left of the dealer will start playing his, her or its hand and each player in a clockwise rotation will play his, her or its hand next. Beginning Declaration hands are played. After Game is called, the caller and any challengers to the caller lay their hands on the playing surface face up. The players may choose to play as partners. The tally for a high scoring game starts at zero points, and the tally for a low scoring game starts at 200 points. The winner of a game is the first player to accumulate 400 points from a starting point of zero in the high game scoring tally or the first player to have all 200 points deducted in the low game scoring tally. Twenty-five bonus points are added if the winner has all black cards and no Game cards. Ten bonus points are added if the winner has all red cards and no Game cards.

FIG. 23 is a system diagram of an exemplary computer-implemented game system 2300, in one embodiment of the invention. As shown, system 2300 includes a plurality of computing devices 2302(1)-2302(n) coupled via the Internet 2304 (or other network) to a game server 2306 that has a processor 2307 for executing software residing in memory (not shown), in order to effect the functionality described in further detail elsewhere herein and is in communication with a game database 2310. Each computing device 2302(n) has a respective processor 2303(n) for executing software residing in memory (not shown), in order to effect the functionality described in further detail elsewhere herein.

Such memory may be volatile (such as RAM), non-volatile (such as ROM, flash memory, etc.) or some combination of the two. The memory may include an operating system suitable for controlling the operation of the computing device, may also include one or more software applications, and may further include program data.

Although in some embodiments, a game consistent with the invention can be implemented as a single-human player (along with computer “players”) or multi-human player game using only a single stand-alone computing device, game system 2300 employs a distributed-computing arrangement, e.g., to permit scaling of game play to a plurality of players, possibly at different geographic locations, facilitated via a central game server 2306. One or more of computing devices 2302(1)-2302(n) may be, for example, located in a gaming establishment, can be a computing device located in a user's home or can be a mobile computing device, such as but not limited to a smartphone, tablet, or laptop computer.

In some embodiments, one or more of computing devices 2302(1)-2302(n) can be located in an establishment, such as a casino or bar. In other embodiments, one or more of computing devices 2302(1)-2302(n) can be a personal computing device that is networked to allow the user to play card games disclosed herein at a remote location, such as in a player's home or other location. In some embodiments, one or more of computing devices 2302(1)-2302(n) is a smartphone or other mobile device. In some embodiments, the rules of game play are stored as data instructions for a smartphone application. The Internet 2304 facilitates communication between the computing devices 2302(1)-2302(n) and one or more servers, such as game server 2306, which host the card games. Alternatively, instead of, or in addition to game play via Internet 2304, one or more other networks selected from among a wide variety of different types of electronic communication networks may be used. For example, the network may be a wide-area network, such as the Internet, a local-area network, a metropolitan-area network, or another type of electronic communication network. The network may include wired and/or wireless data links. A variety of communications protocols may be used for communication including, but not limited to, Ethernet, Transport Control Protocol (TCP), Internet Protocol (IP), Hypertext Transfer Protocol (HTTP), SOAP, remote procedure call protocols, and/or other types of communications protocols.

In some embodiments, game server 2306 is a web server, wherein computing devices 2302(1)-2302(n) include web browsers that communicate with the web server to request and retrieve data. The data is then displayed to the user, such as using a web browser software application. In some embodiments, the various operations, methods, and rules disclosed herein are implemented by instructions stored in memory. When the instructions are executed by the respective processor 2303(n) of one or more of computing devices 2302(1)-2302(n), the instructions cause the processor to perform one or more of the operations or methods disclosed herein. Examples of operations include the operations of game play and enforcement of one or more rules of the game.

In one embodiment, a card game consistent with embodiments of the invention may be played with players and a dealer using game system 2300. As described above, game system 2300 includes at least one server 2306 to host the card game and computing devices 2302(1)-2302(n) communicably coupled to server 2306 through the Internet 2304. Accordingly, the card game may be played by players interacting with each other and with game server 2306 via respective computing devices 2302(1)-2302(n), as described in further detail elsewhere herein.

For example, in computer-implemented embodiments, game play activity described above, including dealing to the players visual representations of physical playing cards generated by computing devices 2302(1)-2302(n), as well as other aspects of game play and scoring, is effected through server 2306, including maintaining and displaying players' hands and stacks of virtual cards, handling various “declarations” made by the players, and so forth. Determination of winners and notifications to players may be automatically effected by server 2306.

As mentioned above, computing devices 2302(1)-2302(n) and game server 2306 all include processors coupled to a memory (not shown) storing instructions, which executed by the respective processor, cause the respective processor to perform one or more operations of dealing, obtaining decisions and/or declarations from players, and determining whether a player has won.

Game database 2310 may be used to store data for games in progress, as well as statistical and other historical data reflective of games already played. Such statistical and/or historical information may be used to maintain, update, and notify players regarding their respective rankings or the like.

Additionally, when implemented in a server-based system, such as game system 2300, in some embodiments, a game consistent with embodiments of the invention may include financial-transaction capabilities to permit players to wager cash, tokens, cash equivalents, or non-cash currency on games, and may further provide capabilities for players to convert between cash, tokens, cash equivalents, and/or non-cash currency in order to enable gambling, wagering, casino-style play, pay-per-play (such as in the case of conventional arcade gaming), and the like for games played via game system 2300.

FIG. 24 is a flow chart showing an exemplary process 2400 for game play of a “Beginning Declaration” game in the computer-implemented embodiment of FIG. 23, the further details of which are described above with reference to FIG. 2A. As shown, the process begins at step 2401. At step 2402, the game server obtains declarations from potential players to indicate the selection of partners. At step 2403, the game server deals cards to the players. At step 2404, the game server establishes face-up and face-down card stacks to display to the players. At step 2405, the game server obtains high/low declarations from the players. At step 2406, the game server allows the players to view their cards. At step 2407, the game server handles game play of the players' beginning declaration hands. At step 2408, the game server maintains the master and discard card stacks as may be appropriate, including shuffling the master card stack and placing one card face-up when the master card stack has been depleted. At step 2409, the game server obtains a declaration of the end of a game from the “caller.” At step 2410, the game server tallies the players' points, reveals their respective hands to one other, determines a winner, and notifies the players of the winner. At step 2411, the process ends.

Although not specifically shown in the figures, game server 2306 could alternatively be configured to implement other game embodiments described herein, such as an “Ending Declaration” game, as shown, e.g., in FIG. 3, in like manner to the operations shown in process 2400 of FIG. 24.

It should further be understood that a method similar to that of process 2400 could be implemented in a non-server environment using only a single computing device, such as a standalone, dedicated gaming hardware device (e.g., a slot machine) or a non-networked personal computer or other processor-based device. In that scenario, multiple players could play at a single physical location using either a shared video display or multiple video displays coupled to that device, and could interact with the device using a single or multiple conventional hardware input methods, such as a keyboard, mouse, joystick, trackpad, touch screen, or the like.

Different embodiments of the invention may be adaptable for different and specialized purposes. Embodiments of the invention may include implementation of a system on a shared server (e.g., for distributed play via Internet) or in a hardened appliance (e.g., as a standalone gaming machine) and may be adapted, e.g., to permit the play of games as described herein in a large heterogeneous environment, such as a private cloud.

It should also be understood that software and/or hardware consistent with embodiments of the invention can be employed, e.g., at endpoint nodes of a network, centrally within a network, as part of a network node, between a standalone pair of interconnected devices not networked to other devices (e.g., between a gaming terminal and a controller), at a user's end, at the server end, or at any other location within a scheme of interconnected devices.

It should be understood that appropriate hardware, software, or a combination of both hardware and software is provided to effect the processing described above, in the various embodiments of the invention. It should further be recognized that a particular embodiment might support one or more of the modes of operation described herein, but not necessarily all of these modes of operation.

It should be understood that various changes in the details, materials, and arrangements of the parts which have been described and illustrated in order to explain the nature of embodiments of the invention may be made by those skilled in the art without departing from the scope of the invention. For example, it should be understood that the inventive concepts of embodiments of the invention may be applied not only in card gaming systems and devices, but also in other applications for which embodiments of the invention may have utility, including non-card gaming systems and devices, such as physical or virtual dice games and the like, as well as games involving manipulatives other than playing cards.

Embodiments of the present invention can take the form of methods and apparatuses for practicing those methods. Such embodiments can also take the form of program code embodied in tangible media, such as magnetic recording media, optical recording media, solid state memory, floppy diskettes, CD-ROMs, hard drives, or any other non-transitory machine-readable storage medium, wherein, when the program code is loaded into and executed by a machine, such as a computer, the machine becomes an apparatus for practicing embodiments of the invention. Embodiments of the invention can also be embodied in the form of program code, for example, stored in a non-transitory machine-readable storage medium including being loaded into and/or executed by a machine, wherein, when the program code is loaded into and executed by a machine, such as a computer, the machine becomes an apparatus for practicing embodiments of the invention. When implemented on a general-purpose processor, the program code segments combine with the processor to provide a unique device that operates analogously to specific logic circuits.

It will be appreciated by those skilled in the art that although the functional components of the exemplary embodiments of the system described herein may be embodied as one or more distributed computer program processes, data structures, dictionaries and/or other stored data on one or more conventional general-purpose computers (e.g., IBM-compatible, Apple Macintosh, and/or RISC microprocessor-based computers), mainframes, minicomputers, conventional telecommunications (e.g., modem, T1, fiber-optic line, DSL, satellite and/or ISDN communications), memory storage means (e.g., RAM, ROM) and storage devices (e.g., computer-readable memory, disk array, direct access storage) networked together by conventional network hardware and software (e.g., LAN/WAN network backbone systems and/or Internet), other types of computers and network resources may be used without departing from the present invention. One or more networks discussed herein may be a local area network, wide area network, internet, intranet, extranet, proprietary network, virtual private network, a TCP/IP-based network, a wireless network (e.g., IEEE 802.11 or Bluetooth), an e-mail based network of e-mail transmitters and receivers, a modem-based, cellular, or mobile telephonic network, an interactive telephonic network accessible to users by telephone, or a combination of one or more of the foregoing.

Embodiments of the invention as described herein may be implemented in one or more computers residing on a network transaction server system, and input/output access to embodiments of the invention may include appropriate hardware and software (e.g., personal and/or mainframe computers provisioned with Internet wide area network communications hardware and software (e.g., CQI-based, FTP, Netscape Navigator™, Mozilla Firefox, Microsoft Internet Explorer™, Google Chrome™, or Apple Safari™ HTML Internet-browser software, and/or direct real-time or near-real-time TCP/IP interfaces accessing real-time TCP/IP sockets) for permitting human users to send and receive data, or to allow unattended execution of various operations of embodiments of the invention, in real-time and/or batch-type transactions. Likewise, a system consistent with the present invention may include one or more remote Internet-based servers accessible through conventional communications channels (e.g., conventional telecommunications, broadband communications, wireless communications) using conventional browser software (e.g., Netscape Navigator™, Mozilla Firefox, Microsoft Internet Explorer™, Google Chrome™, or Apple Safari™). Thus, embodiments of the present invention may be appropriately adapted to include such communication functionality and Internet browsing ability. Additionally, those skilled in the art will recognize that the various components of the server system of the present invention may be remote from one another, and may further include appropriate communications hardware/software and/or LAN/WAN hardware and/or software to accomplish the functionality herein described.

Each of the functional components of embodiments of the present invention may be embodied as one or more distributed computer-program processes running on one or more conventional general purpose computers networked together by conventional networking hardware and software. Each of these functional components may be embodied by running distributed computer-program processes (e.g., generated using “full-scale” relational database engines such as IBM DB2™, Microsoft SQL Server™, Sybase SQL Server™, or Oracle 10g™ database managers, and/or a JDBC interface to link to such databases) on networked computer systems (e.g., including mainframe and/or symmetrically or massively-parallel computing systems such as the IBM SB2™ or HP 9000™ computer systems) including appropriate mass storage, networking, and other hardware and software for permitting these functional components to achieve the stated function. These computer systems may be geographically distributed and connected together via appropriate wide- and local-area network hardware and software. In one embodiment, data stored in the database or other program data may be made accessible to the user via standard SQL queries for analysis and reporting purposes.

Primary elements of embodiments of the invention may be server-based and may reside on hardware supporting an operating system such as Microsoft Windows NT/2000™ or UNIX.

Components of a system consistent with embodiments of the invention may include mobile and non-mobile devices. Mobile devices that may be employed in embodiments of the present invention include personal digital assistant (PDA) style computers, e.g., as manufactured by Apple Computer, Inc. of Cupertino, Calif., or Palm, Inc., of Santa Clara, Calif., and other computers running the Android, Symbian, RIM Blackberry, Palm webOS, or iPhone operating systems, Windows CE™ handheld computers, or other handheld computers (possibly including a wireless modem), as well as wireless, cellular, or mobile telephones (including GSM phones, J2ME and WAP-enabled phones, Internet-enabled phones and data-capable smart phones), one- and two-way paging and messaging devices, laptop computers, etc. Other telephonic network technologies that may be used as potential service channels in a system consistent with embodiments of the invention include 2.5G cellular network technologies such as GPRS and EDGE, as well as 3G technologies such as CDMA1xRTT and WCDMA2000, and 4G technologies. Although mobile devices may be used in embodiments of the invention, non-mobile communications devices are also contemplated by embodiments of the invention, including personal computers, Internet appliances, set-top boxes, landline telephones, etc. Clients may also include a PC that supports Apple Macintosh™, Microsoft Windows 95/98/NT/ME/CE/2000/XP/Vista/7/8™, a UNIX Motif workstation platform, or other computer capable of TCP/IP or other network-based interaction. In one embodiment, no software other than a web browser may be required on the client platform.

Alternatively, the aforesaid functional components may be embodied by a plurality of separate computer processes (e.g., generated via dBase™, Xbase™, MS Access™ or other “flat file” type database management systems or products) running on IBM-type, Intel Pentium™ or RISC microprocessor-based personal computers networked together via conventional networking hardware and software and including such other additional conventional hardware and software as may be necessary to permit these functional components to achieve the stated functionalities. In this alternative configuration, since such personal computers typically may be unable to run full-scale relational database engines of the types presented above, a non-relational flat file “table” (not shown) may be included in at least one of the networked personal computers to represent at least portions of data stored by a system according to embodiments of the present invention. These personal computers may run the Unix, Microsoft Windows NT/2000 or Windows 95/98/NT/ME/CE/2000/XP/Vista/7/8™ operating systems. The aforesaid functional components of a system according to the invention may also include a combination of the above two configurations (e.g., by computer program processes running on a combination of personal computers, RISC systems, mainframes, symmetric or parallel computer systems, and/or other appropriate hardware and software, networked together via appropriate wide- and local-area network hardware and software).

A system according to embodiments of the present invention may also be part of a larger system including multi-database or multi-computer systems or “warehouses” wherein other data types, processing systems (e.g., transaction, financial, administrative, statistical, data extracting and auditing, data transmission/reception, and/or accounting support and service systems), and/or storage methodologies may be used in conjunction with those of the present invention to achieve additional functionality.

In one embodiment, source code may be written in an object-oriented programming language using relational databases. Such an embodiment may include the use of programming languages such as C++ and toolsets such as Microsoft's.Net™ framework. Other programming languages that may be used in constructing a system according to embodiments of the present invention include Java, HTML, Perl, UNIX shell scripting, assembly language, Fortran, Pascal, Visual Basic, and QuickBasic. Those skilled in the art will recognize that embodiments of the present invention may be implemented in hardware, software, or a combination of hardware and software.

Accordingly, the terms “server,” “computer,” and “system,” as used herein, should be understood to mean a combination of hardware and software components including at least one machine having a processor with appropriate instructions for controlling the processor. The singular terms “server,” “computer,” and “system” should also be understood to refer to multiple hardware devices acting in concert with one another, e.g., multiple personal computers in a network; one or more personal computers in conjunction with one or more other devices, such as a router, hub, packet-inspection appliance, or firewall; a residential gateway coupled with a set-top box and a television; a network server coupled to a PC; a mobile phone coupled to a wireless hub; and the like. The term “processor” should be construed to include multiple processors operating in concert with one another.

It should also be appreciated from the outset that one or more of the functional components may alternatively be constructed out of custom, dedicated electronic hardware and/or software, without departing from the present invention. Thus, embodiments of the invention are intended to cover all such alternatives, modifications, and equivalents as may be included within the spirit and broad scope of the invention.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments.

It should be understood that in some embodiments the steps of the exemplary methods set forth herein, if any, are not necessarily required to be performed in the order described, and the order of the steps of such methods should be understood to be merely exemplary. In some embodiments, as clearly described, the steps are required to be performed in the order described. Likewise, additional steps may be included in such methods, and certain steps may be omitted or combined, in methods consistent with various embodiments of the present invention.

It will be further understood that various changes in the details, materials, and arrangements of the parts which have been described and illustrated in order to explain the nature of this disclosure may be made by those skilled in the art without departing from the scope of the disclosure as expressed in the following claims.

Reference is now made to FIGS. 11-14.

I, John Hanlon, have invented a new design for a playing card as set forth in the following specification:

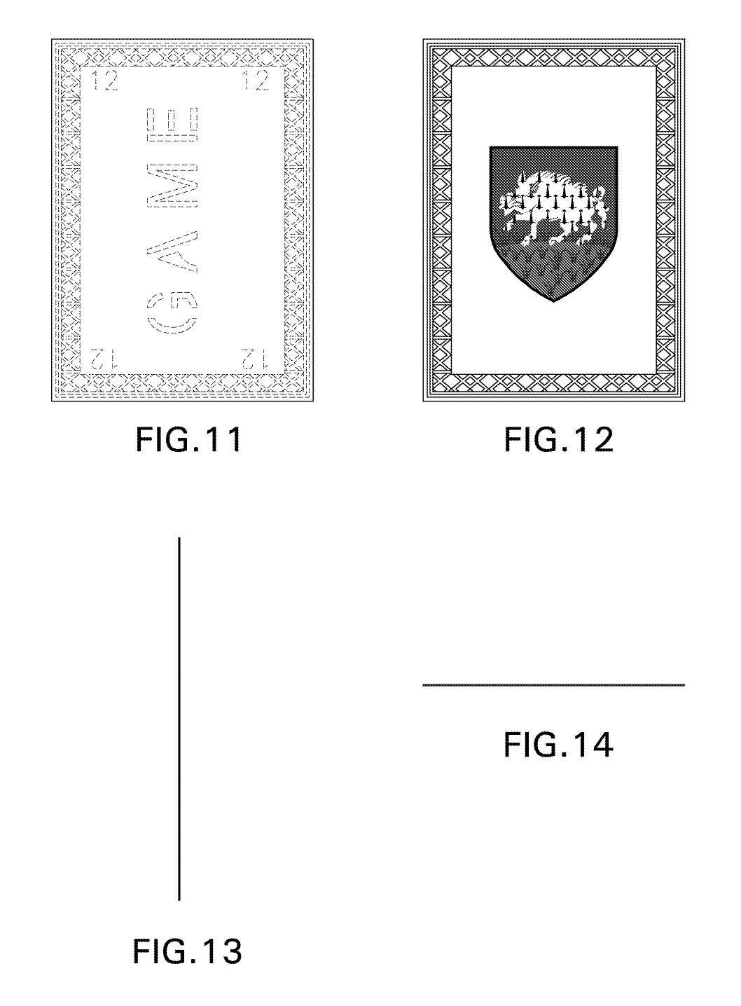

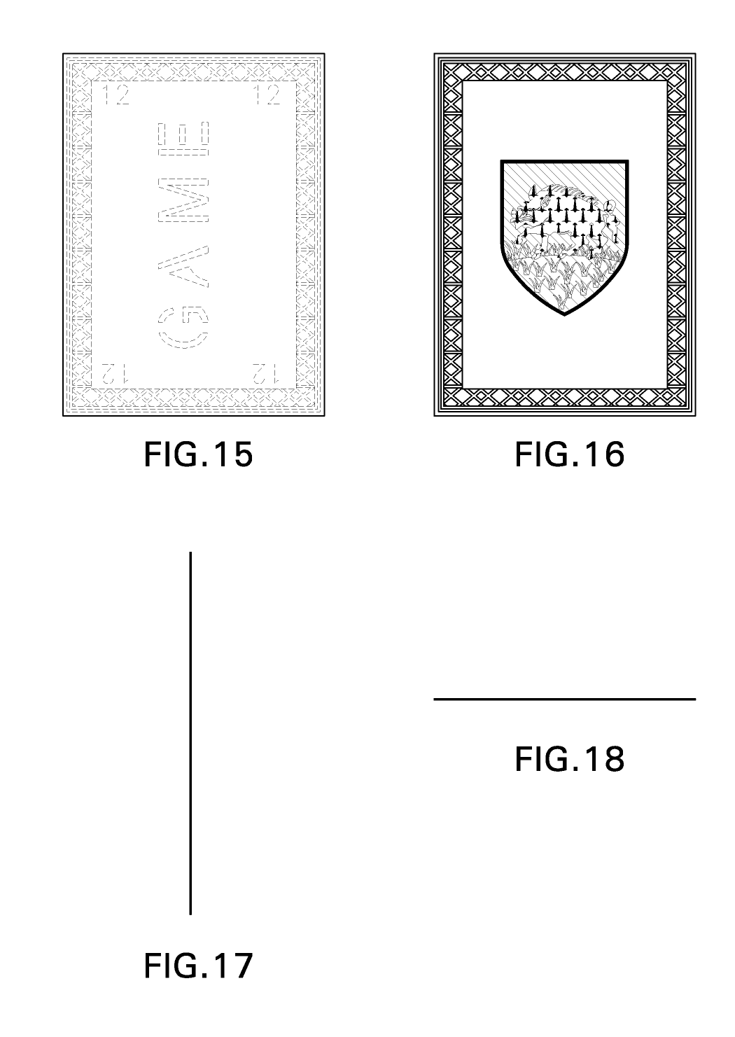

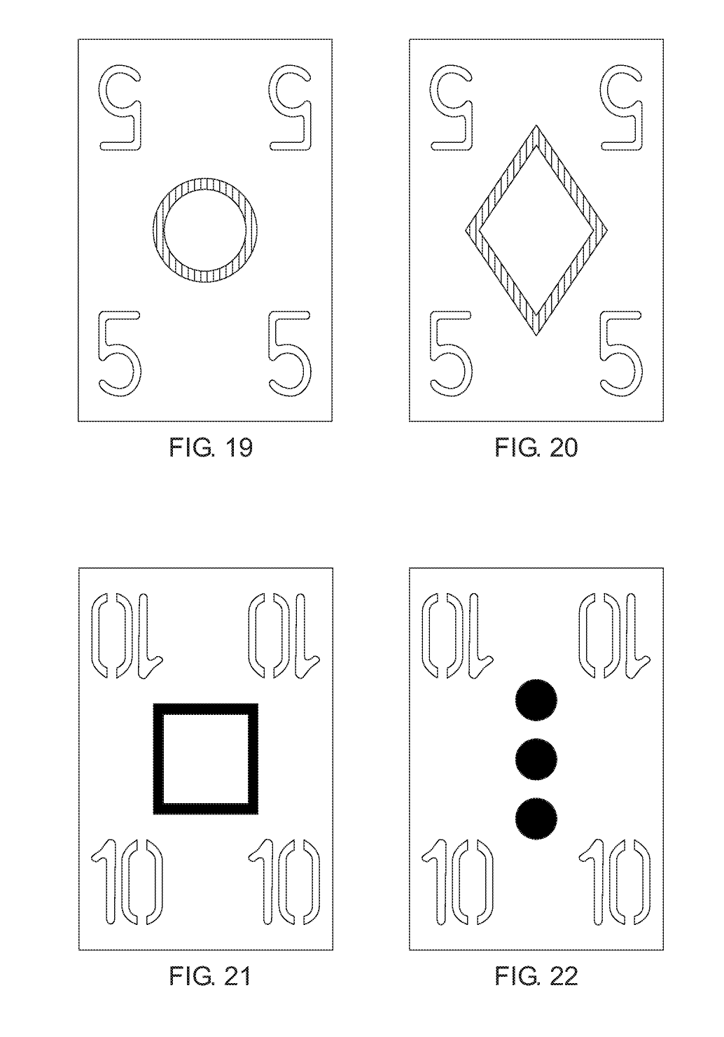

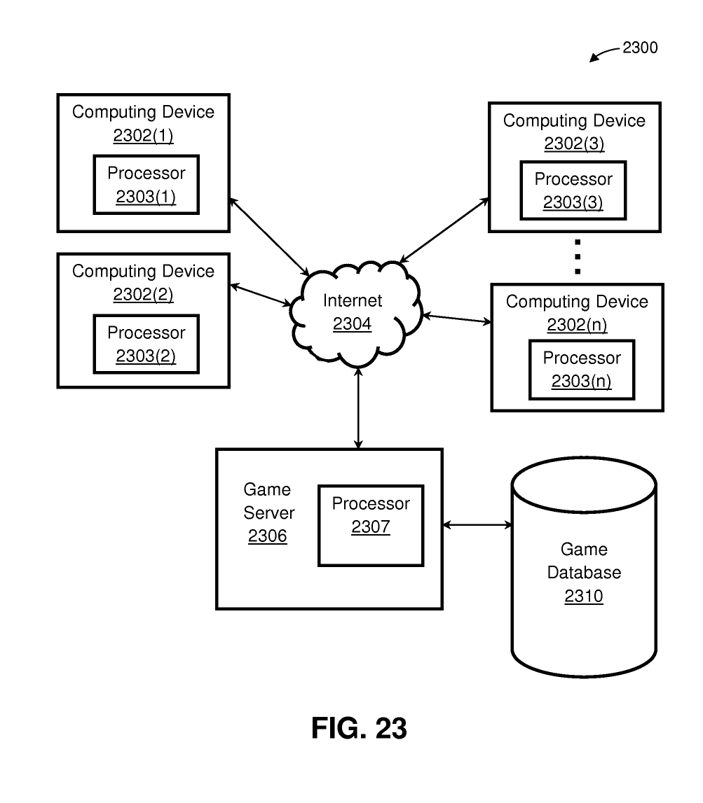

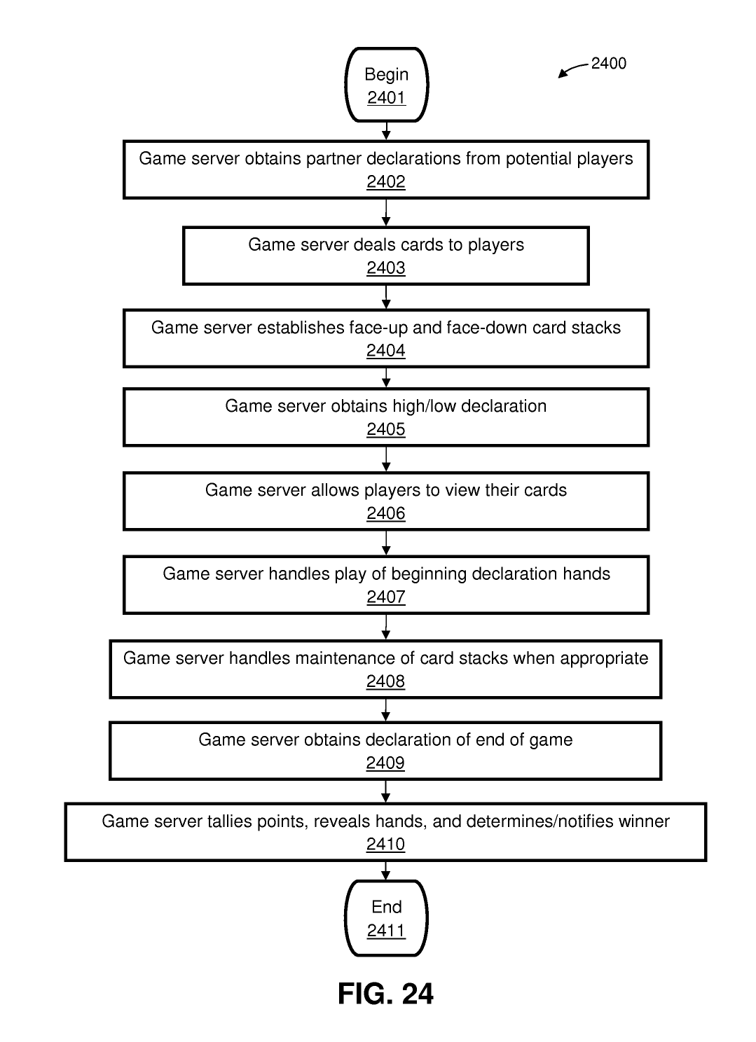

FIG. 12 is a rear elevational view of a playing card showing my new design;
FIG. 11 is a front elevational view thereof;
FIG. 13 is a side view thereof;
FIG. 14 is a top view thereof.
Reference is now made to FIGS. 15-22.

I, John Hanlon, have invented a new design for a playing card as set forth in the following specification:

FIG. 16 is a rear elevational view of a playing card showing my new design;
FIG. 15 is a front elevational view thereof;
FIG. 17 is a side view thereof;
FIG. 18 is a top view thereof.
In other and/or alternative embodiments,
FIG. 19 is a front elevational view, FIG. 17 is a side view thereof; FIG. 18 is a top view thereof, and the rear elevational view is not claimed, of a playing card showing my new design.
FIG. 20 is a front elevational view, FIG. 17 is a side view thereof; FIG. 18 is a top view thereof, and the rear elevational view is not claimed of a playing card showing my new design.
FIG. 21 is a front elevational view, FIG. 17 is a side view thereof; FIG. 18 is a top view thereof, and the rear elevational view is not claimed, of a playing card showing my new design.
FIG. 22 is a front elevational view, FIG. 17 is a side view thereof; FIG. 18 is a top view thereof, and the rear elevational view is not claimed, of a playing card showing my new design.
In other alternative embodiments,
FIG. 19 is a front elevational view, FIG. 17 is a side view thereof; FIG. 18 is a top view thereof, and FIG. 16 is a rear elevational view of a playing card showing my new design.
FIG. 20 is a front elevational view, FIG. 17 is a side view thereof; FIG. 18 is a top view thereof, and FIG. 16 is a rear elevational view of a playing card showing my new design.
FIG. 21 is a front elevational view, FIG. 17 is a side view thereof; FIG. 18 is a top view thereof, and FIG. 16 is a rear elevational view of a playing card showing my new design.
FIG. 22 is a front elevational view, FIG. 17 is a side view thereof; FIG. 18 is a top view thereof, and FIG. 16 is a rear elevational view of a playing card showing my new design. In yet another alternative embodiment,
FIG. 15 is a front elevational view, FIG. 17 is a side view, FIG. 18 is a top view, and the rear elevational view is not claimed, of a playing card showing my new design.

The embodiments covered by the claims in this application are limited to embodiments that (1) are enabled by this specification and (2) correspond to statutory subject matter. Non-enabled embodiments and embodiments that correspond to non-statutory subject matter are explicitly disclaimed even if they fall within the scope of the claims.

I claim:

1. (canceled)

2. A system for playing a card game on the Internet, said system comprising providing at least one processor, said at least one processor comprising at least one game server, and providing at least one non-transitory computer-readable media comprising instructions that can cause said at least one processor to:
provide a high scoring option and a low scoring option during each hand of a card game comprising at least one hand and at least two players, and during each said at least one hand requiring from at least one of said at least two players to indicate to all the other players that said at least one of said at least two players is declaring use of said high scoring option or said low scoring option;
deal cards to said players, said cards comprising virtual representations of cards;
allow at least all of the human players to view the virtual cards that they have been dealt without allowing any of the other players to see the their cards and without allowing any of the players to see the cards that have been dealt to any of the other players;
establish a virtual remaining card deck after a designated number of the cards have been dealt to each player and placing face up one of the remaining virtual cards for at least all the human players to see;
process decisions made by at least all of the human players during the playing of said virtual card game by said more than one player after each player has had the opportunity to see his, her or its cards;
obtain the declaration of the end of the game;
tally points, reveal the virtual hands of at least the winning player and identify the winner of the hand.

3. The system of claim 2, wherein said at least one processor stores current game data as well as statistics and historical data to notify players of said player's ranking.

4. The system of claim 2, wherein a scoring method is provided, said scoring method comprising providing for each player a possible high scoring tally and a possible low scoring tally.

5. The system of claim 2, said system further comprising a heterogeneous environment such as a private cloud.

6. The system of claim 2, wherein all of the players indicate whether they will be playing the hand using the high scoring option or the low scoring option before viewing their cards for the hand.

7. The system of claim 2, wherein the player who makes said declaration of the end of the game must also at the time of declaring the end of the game disclose whether the caller is using the high scoring option or the low scoring option for that hand.

8. The system of claim 2, wherein when said declaration of the end of the game is made by a human player, said player presses at least one key, clicks at least one button click and/or touches at least one screen.

9. A system for playing a card game on a computing device, said system comprising providing at least one processor, said at least one processor comprising at least one stand alone computing device, and providing at least one non-transitory computer-readable media comprising instructions that can cause said at least one processor to:
provide a high scoring option and a low scoring option during each hand of a card game comprising at least one hand and at least two players;
provide at least one virtual deck of cards, wherein said at least one deck of cards further comprises at least one first set of cards, said at least one first set of cards comprising more than one card and each card in said first set comprising scoring indicia that indicates the same scoring value, said at least one deck of cards further comprising at least one second set of cards comprising more than one card and each card in said second set comprising scoring indicia that indicates the same scoring value, said scoring indicia indicating point values, wherein each card in said at least one first set of cards represents a single fixed point value that is knowable to all the players before the game commences and each card in said at least one second set of cards represents a single fixed point value that is knowable to all the players before the game commences, and wherein said point value for said cards in said first set is different than said point value for said cards in said second set;
deal cards to said players, said cards comprising virtual representations of cards,
allow at least all of the human players to view the virtual cards that they have been dealt without allowing any of the other human players to see the their cards and without allowing any of the players to see the cards that have been dealt to any of the other players;
establish a virtual remaining card deck after a predetermined number of the cards have been dealt to each player and placing face up one of the remaining virtual cards for all the players to see or identify;
process decisions made by at least all of the human players during the playing of said virtual card game by said more than one player after each player has had the opportunity to see his, her or its cards;
obtain the declaration of the end of the game;
tally points, reveal the virtual hands of at least the winning player and identify the winner of the hand.

10. The system of claim 9, wherein when said declaration of the end of the game is made by a human player, said player presses at least one key, clicks at least one button click and/or touches at least one screen.

11. The system of claim 9, wherein said at least one processor stores current game data as well as statistics and historical data to notify players of said player's ranking.

12. The system of claim 9, wherein a scoring method is provided, said scoring method comprising providing for each player a possible high scoring tally and a possible low scoring tally.

13. The system of claim 9, wherein at least one of said at least two players can view said virtual cards on at least one video player.

14. The system of claim 9 wherein during each said at least one hand, at least one of said at least two players gives an indication to all the other players that said at least one of said at least two players is declaring use of said high scoring option or said low scoring option.

15. A system for playing a card game on a network, said system comprising providing at least one processor, said at least one processor comprising at least one server, and providing at least one non-transitory computer-readable media comprising instructions that can cause said at least one processor to:
provide a high scoring option and a low scoring option during each hand of a card game comprising at least one hand and at least two players;
provide at least one virtual deck of cards, wherein said at least one deck of cards further comprises at least one first set of cards, said at least one first set of cards comprising more than one card and each card in said first set comprising scoring indicia that indicates the same scoring value, said at least one deck of cards further comprising at least one second set of cards comprising more than one card and each card in said second set comprising scoring indicia that indicates the same scoring value, said scoring indicia indicating point values, wherein each card in said at least one first set of cards represents a single fixed point value that is knowable to all the players before the game commences and each card in said at least one second set of cards represents a single fixed point value that is knowable to all the players before the game commences, and wherein said point value for said cards in said first set is different than said point value for said cards in said second set;
deal cards to said players, said cards comprising virtual representations of cards, allow at least all of the human players to view the virtual cards that they have been dealt without allowing any of the other human players to see the their cards and without allowing any of the players to see the cards that have been dealt to any of the other players;
establish a virtual remaining card deck after a predetermined number of the cards have been dealt to each player and placing face up one of the remaining virtual cards for all the players to see or identify;
process decisions made by at least all of the human players during the playing of said virtual card game by said more than one player after each player has had the opportunity to see his, her or its cards;
obtain the declaration of the end of the game;
tally points, reveal the virtual hands of at least the winning player and identify the winner of the hand.

16. The system of claim 15, wherein when said declaration of the end of the game is made by a human player, said player presses at least one key, clicks at least one button click and/or touches at least one screen.

17. The system of claim 16 wherein said network further comprises the internet.

18. The system of claim 15 wherein said at least one processor stores current game data as well as statistics and historical data to notify players of said player's ranking.

19. The system of claim 15 wherein during each said at least one hand, at least one of said at least two players gives an indication to all the other players that said at least one of said at least two players is declaring use of said high scoring option or said low scoring option.

20. The system of claim 15 wherein said network further comprises a heterogeneous environment such as a private cloud.

21. The system of claim 15 wherein said network further comprises the internet.
